(19) United States
(12) Patent Application Publication
(10) Pub. No.: US 2006/0070189 A1
(43) Pub. Date: Apr. 6, 2006

(54) Textile treatment agent

(76) Inventors: Wilfried Raehse, Duesseldorf (DE); Ulrike Ruffer, Duesseldorf (DE)

Correspondence Address: DANN DORFMAN HERRELL AND SKILLMAN;A PROFESSIONAL CORPORATION, 1601 MARKET STREET, SUITE 2400, PHILADELPHIA, PA, 19103-2307, US

(21) Appl. No.: 11/230,199

(22) Filed: Sep. 19, 2005

Related U.S. Application Data
(63) Continuation of application No. PCT/EP04/02232, filed on Mar. 5, 2004.

(30) Foreign Application Priority Data
Mar. 17, 2003 (DE) DE 103 11 852.7

(51) Int. Cl. C11D 3/00

(52) U.S. Cl. 8/115.51

(57) ABSTRACT

A textile aftertreatment composition comprising (a) a skin-protecting oil and (b) urea and/or urea derivative; lactic acid and/or a lactic salt; citric acid and/or a citric acid salt wherein the composition is in the form of an emulsion. The composition is conducive directly or indirectly to the health of the skin and can be used as a supplement to the classical textile treatment compositions such as laundry detergents or fabric softeners.

### CROSS REFERENCE TO RELATED APPLICATIONS.

This application is a continuation under 35 U.S.C. § 365(c) and 35 U.S.C. § 120 of international application PCT/EP2004/002232, filed Mar. 5, 2004. This application also claims priority under 35 U.S.C. § 119 of DE 103 11 852.7, filed Mar. 17, 2003, which is incorporated herein by reference in its entirety.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

(1) Field of the Invention

The invention relates to a textile treatment composition, to a laundry treatment or aftertreatment composition, to a laundry detergent and to the use of the textile treatment or aftertreatment composition in the course of a washing or textile drying process or textile treatment process. The invention further relates to a conditioning substrate which comprises a textile treatment composition, and to a conditioning process using the conditioning substrate in a textile drying process. The invention further relates to a laundry detergent.

With a surface area of up to 2 m², the skin is the largest organ of the human body and is exposed to a variety of harmful environmental influences. The number of humans having sensitive skin and dermatological problems, which can range from slight skin irritations through sensitizations, allergies up to neurodermititis, is increasing. It is obvious that textiles can play an important role for skin health, especially because human skin is usually in direct contact with textile garments for most of the day and night.

The classical treatment of textile garments with textile treatment compositions satisfies a variety of needs with regard to the textiles to be treated therewith, for example the hygiene, the fragrance or the softness.

In this context, it has to be considered that textile garments as such or residues remaining thereon, which remain in the textile structures after a cleaning operation, for example, can damage the skin.

(2) Description of Related Art, Including Information Disclosed Under 37 C.F.R. §§ 1.97 and 1.98

To reduce these problems, rinse aids, for example, are sometimes used to remove laundry detergent residues in order to obtain textiles with better skin compatibility. For instance, DE 199 23 303 C2 describes rinse aids which comprise certain minimum amounts of citric acid, lactic acid, cyclodextrin and ascorbic acid, and are suitable for producing textiles with better skin compatibility.

In addition, there exists the additional possibility of finishing textiles with substances which impart to the skin a cosmetic or purely sensory advantage, and which release these substances to the skin on contact of skin and textiles. One such route consists, for example, in finishing textile treatment compositions with such substances in such a way that these substances are transferred in the course of the conventional textile treatment, for example in the course of the fabric softening, to the textile fibers, in which case the textile fiber acts as a temporary host and transfers the substances to the skin on contact.

Accordingly, EP 0 789 070 describes fabric softener compositions, which discloses skincare ingredients, for example in the form of silicones. When laundry is treated with such fabric softener compositions and this laundry is then brought into very intensive contact with the skin, traces of the aforementioned ingredients and/or traces of silicone are found on the skin.

Against this background, it is an object of the present invention to provide compositions for textile treatment and/or conditioning which enable textiles treated therewith to be less problematic for the health of the skin with regard to dermatological problems than textiles treated with conventional compositions, so that, for example, the risk of skin irritations as a consequence of the skin/treated textile contact is not additionally increased, but rather, if anything, reduced, or so that already irritated or sensitized skin is not damaged further by the contact with the treated textile.

This invention therefore provides a textile treatment composition, characterized in that it comprises one or more skin-protecting and/or skin-healing active substances.

The subject matter of the invention offers numerous advantages. It is advantageous that laundry treatment compositions, in the context of a holistic and multi-functional approach, also assume special functions by virtue of them being, for example, additionally conducive directly or indirectly to the health of the skin. Such textile treatment compositions should be seen as supplements to the classical textile treatment compositions such as laundry detergents or fabric softeners.

It is advantageous to contemplate the health of the skin actually in the course of textile treatment. The aim is to enable the treatment of textile garments with skin-functional laundry treatment compositions which make an active positive contribution to the health of the skin which comes into contact with the textiles treated therewith.

In the extended context of this invention, the following documents should also be mentioned.

U.S. Pat. No. 5,610,189 describes a composition for treating domestic laundry, which comprises tea tree oil.

DE 197 37 072 A1 describes the use of a mixture comprising a citrus oil concentrate and castor oil for laundry cleaning.

DE 198 21 106 A1 discloses a mite-killing cleaning composition having a high content of essential oils. The essential oils may be tree oils such as tea tree oil or cedar oil, or vegetable oils such as caraway oil and dill oil.

U.S. Pat. No. 6,494,920 B1 describes cleaning compositions with fabric softening action, which comprise aloe vera and ester quats.

JP 06136386 discloses cleaning compositions comprising skin-protecting compositions based on Aspalathus Linearis.

WO 00/40687 A1 describes a textile care composition which comprises a softener and a protein, it being possible for the protein to be deposited on the fiber. It can later be released from the fiber to the skin.

U.S. Pat. No. 3,640,883 discloses pulverulent fine laundry detergents which contain 1-5% by weight of a skin-protecting substance.

U.S. Pat. No. 6,413,529 B1 claims a cleaning towel which comprises a cleaning liquid which comprises essential natural oils.

Against this background, it is an object of the present invention to provide compositions for textile treatment and/or conditioning which enable textiles treated therewith to be less problematic for the health of the skin with regard to dermatological problems than textiles treated with conventional compositions, so that, for example, the risk of skin irritations as a consequence of the skin/treated textile contact is not additionally increased, but rather, if anything, reduced, or so that already irritated or sensitized skin is not damaged further by the contact with the treated textile.

### BRIEF SUMMARY OF THE INVENTION

This invention, therefore, provides textile treatment compositions in the form of an emulsion which comprises one or more skin-protecting active substances or skin-protecting active substances and skin-healing active substances, and includes:
a) a skin-protecting oil selected from the group of: algae oil Oleum Phaeophyceae, apricot kernel oil Prunus armeniaca, arnica oil Arnica montana, avocado oil Persea americana, borage oil Borago officinalis, calendula oil Calendula officinalis, camellia oil Camellia oleifera, thistle oil Carthamus tinctorius, peanut oil Arachis hypogaea, hemp oil Cannabis sativa, hazelnut oil Corylus avellana, St. John's wort oil Hypericum perforatum, jojoba oil Simondsia chinensis, carrot oil Daucus carota, coconut oil Cocos nucifera, pumpkinseed oil Curcubita pepo, kukui nut oil Aleurites moluccana, macadamia nut oil Macadamia ternifolia, almond oil Prunus dulcis, peach kernel oil Prunus persica, rapeseed oil, Brassica oleifera, black cumin oil Nigella sativa, sesame oil Sesamium indicum, sunflower oil Helianthus annus, grapeseed oil Vitis vinifera, walnut oil Juglans regia, wheatgerm oil Triticum sativum, and
b) additionally urea and/or its derivatives and/or lactic acid and/or citric acid and/or its salts.

### BRIEF DESCRIPTION OF THE SEVERAL VIEWS OF THE DRAWING(S)

Not Applicable

### DETAILED DESCRIPTION OF THE INVENTION.

The subject matter of the invention offers numerous advantages. It is advantageous that laundry treatment compositions, in the context of a holistic and multifunctional approach, also assume special functions by virtue of them being, for example, additionally conducive directly or indirectly to the health of the skin. Such textile treatment compositions should be seen as supplements to the classical textile treatment compositions such as laundry detergents or fabric softeners.

It is advantageous to contemplate the health of the skin actually in the course of textile treatment. The aim is to enable the treatment of textile garments with skin-functional laundry treatment compositions.

However, there is no desire for such strong effectiveness in the context of the invention, since, although it would undoubtedly lead to the elimination of harmful germs or the like, it would also impair the natural skin flora of the human.

The particular advantage of the antiseptic active substances which can be used in accordance with the invention results from synergistic interaction of these substances with the general functional mechanisms of human skin, since they reduce mild antiseptic substances, for example germs including harmful germs, but do not completely eliminate them, i.e. to the extent of freedom from germs. There thus remain sufficient germs on the skin to train the self-regulating powers of human skin and thus to reinforce them. The interaction of the self-regulating powers of the skin with the antiseptic capacity of the active substances present in the composition sustains the general functional mechanisms of the skin. This is of great advantage precisely with regard to already irritated and/or otherwise damaged skin. In the case of already irritated and/or sensitized and/or otherwise damaged or else particularly sensitive skin, the self-regulating powers of the skin are sometimes no longer capable, even if only temporarily, of ensuring the health of the skin on their own. In synergistic interaction with the inventive compositions and their inventive use, these self-regulating powers are sustained, trained and strengthened.

In this way, the textile treatment composition or the laundry treated with it sustains the natural skin flora of the human.

In order not to impair the natural skin flora of the human, it is important to (very substantially) exclude substances which have a strong disinfectant or antiseptic action, for example glutaraldehyde, but simultaneously harbor high allergization potential and irritate the skin and mucous membranes.

Unexpectedly, compositions of such an embodiment are particularly suitable for their purpose when the antiseptic substance is an oil, preferably an essential oil.

This antiseptic oil is preferably essential oil which is in particular selected from the group of angelica fine—Angelica archangelica, aniseed—Pimpinella Anisum, benzoin siam—Styrax tokinensis, cabreuva—Myrocarpus fastigiatus, cajeput—Melaleuca leucadendron, rockrose—Cistrus ladaniferus, copaiba balsam—Copaifera reticulata, costus root—Saussurea discolor, silver fir needle—Abies alba, elemi—Canarium luzonicum, fennel—Foeniculum dulce, spruce needle—Picea abies, geranium—Pelargonium graveolens, ho leaves—Cinnamonum camphora, immortelle (straw flower)—Helichrysum ang., ginger extra—Zingiber off., St. John's wort—Hypericum perforatum, jojoba, German camomile—Matricaria recutita, blue camomile fine—Matricaria chamomilla, Roman camomile—Anthemis nobilis, wild camomile—Ormensis multicaulis, carrot—Daucus carota, mugo pine—Pinus mugho, lavandin—Lavendula hybrida, litsea cubeba—(May Chang), manuka—Leptospermum scoparium, melissa—Melissa officinalis, maritime pine—Pinus pinaster, myrrh—Commiphora molmol, myrtle—Myrtus communis, neem—Azadirachta, niaouli—(MQV) Melaleuca quin. viridiflora, palma rosa—Cymbopogom martini, patchouli—Pogostemon patschuli, peru balsam—Myroxylon balsamum var. pereirae, raventsara aromatica, rosewood—Aniba rosae odora, sage—Salvia officinalis, horsetail—Equisetaceae, yarrow extra—Achillea millefolia, ribwort—Plantago lanceolata, styrax—Liquidambar orientalis, tagetes (marigold)—Tagetes patula, tea tree—Melaleuca alternifolia, tolu balsam—Myroxylon Balsamum L., Virginia cedar—Juniperus virginiana, incense (olibanum)—Boswellia carteri, white fir —Abies alba.

A further advantage of the above-named essential oils lies in their particular multifunctionality which arises not only from the mild antiseptic activity described but also from a multitude of further desirable organoleptic properties which are attributable precisely to these oils. In most cases, a mucus-releasing action is attributed to these oils, since they exert a mild, positive, stimulus to the mucous membranes of the respiratory organs. In addition, a desirable feeling of warmth can be attained. Deodorizing, palliative, perfusion-promoting, relaxing actions have been observed by the applicant in connection with the inventive use of these named oils and have been recognized as being particularly advantageous. The organoleptic properties of these oils are generally not shaped by the main components, but rather by the secondary or trace constituents, of which there can often be hundreds and which sometimes act synergistically. Another advantage in connection with the oils mentioned is their harmonizing fragrance and odor, which leads in many cases to positive feelings in humans.

In this way, the textile treatment composition or the laundry treated with it does not only sustain the natural skin flora of the human, but also helps the human organism to gain additional advantages of the type just described.

Against this background, tea tree oil in particular is of great advantage for the subject matter of the invention. In addition to its notable germicidal, antiseptic, fungicidal, antiviral, wound-healing, inflammation-inhibiting, scar-promoting action, it has outstanding skin compatibility and offers a further wide spectrum of use, for example with regard to sustaining treatment of colds or of rheumatic disorders, gout, muscle pain.

In a further particular embodiment, a skin-protecting substance is employed. This skin-protecting substance is advantageously a skin-protecting oil, for example a carrier oil, in particular selected from the group of algae oil Oleum Phaeophyceae, aloe vera oil Aloe vera brasiliana, apricot kernel oil Prunus armeniaca, arnica oil Arnica montana, avocado oil Persea americana, borage oil Borago officinalis, calendula oil Calendula officinalis, camellia oil Camellia oleifera, thistle oil Carthamus tinctorius, peanut oil Arachis hypogaea, hemp oil Cannabis sativa, hazelnut oil Corylus avellana, St. John's wort oil Hypericum perforatum, jojoba oil Simondsia chinensis, carrot oil Daucus carota, coconut oil Cocos nucifera, pumpkinseed oil Curcubita pepo, kukui nut oil Aleurites moluccana, macadamia nut oil Macadamia ternifolia, almond oil Prunus dulcis, olive oil Olea europaea, peach kernel oil Prunus persica, rapeseed oil Brassica oleifera, castor oil Ricinus communis, black cumin oil Nigella sativa, sesame oil Sesamium indicum, sunflower oil Helianthus annus, grapeseed oil Vitis vinifera, walnut oil Juglans regia, wheatgerm oil Triticum sativum, and the advantageous oils among these are in particular borage oil, hemp oil and almond oil.

All of the oils just listed are natural emollients, i.e. agents which make body tissue softer and more supple, and reduce the roughness of the skin. These oils thus firstly have skincare action. Secondly, precisely these oils have further specific actions which entail synergistic interaction with the skin and its self-regulating powers and enable protection even under adverse conditions.

An example of a particularly preferred oil in the context of this invention is hemp oil. Hemp oil, which has a high proportion of essential fatty acids and also up to 6% by weight of the valuable γ-linolenic acid (GLA) additionally has anti-inflammatory action, is mildly analgesic, has healing and care action, improves the skin structure and prevents manifestations of aging. It improves renewal processes in the tissue and exerts high regenerating action on injured tissue. In addition, it can increase the care properties or other properties of other oils, in particular all oils mentioned explicitly here. Since essential fatty acids play a crucial role in the maintenance of the barrier function of the skin, because they help to regulate and to normalize the transepidermal loss of water through the skin, hemp oil plays a particular role in the context of this invention as a consequence of its high GLA content, since localized treatment with GLA leads to the strongest reduction in the transepidermal loss of water in the event of disrupted transepidermal loss of water. Moreover, hemp oil exhibits further positive actions on the human organism with regard to arteriosclerosis, rheumatoid arthritis, diabetic neuropathy up to and including heart complaints.

An oil which is equally preferred in the context of this invention is borage oil.

Owing to its high GLA content (up to 25% by weight), it has comparable properties and advantages to hemp oil.

In a preferred embodiment, the inventive textile treatment compositions comprise skin-healing active substances which have a minimum content of 0.1% by weight of GLA, preferably of 0.3% by weight, more preferably of 0.5% by weight. These also include, for example, black cumin oil, evening primrose oil, echium oil, trichodesma oil and the kernel oil of the blackcurrant.

An oil which is likewise preferred is almond oil. It is notable in that it can enhance the action of other oils, which is why it is used advantageously in combination with other oils.

In a further embodiment of the invention, it is advantageous to combine different oils, i.e. to combine the oils having antiseptic action with those having skin-protecting action, or else to combine those having antiseptic action and those having skin-protecting action with one another.

In a preferred embodiment, the textile treatment compositions contain at least 1% by weight, preferably at least 5% by weight, more preferably at least 10% by weight, most preferably at least 15% by weight, of one or more skin-protecting and/or skin-healing active substances or oils or essential oils, and it is even more advantageous when even at least 20% by weight, in particular even more than 25% by weight, at best even more than 30% by weight, of one or more skin-protecting and/or skin-healing active substances or oils or essential oils are present in the textile treatment composition.

In a preferred embodiment, the textile treatment composition is dye-free. The freedom from dyes is particularly advantageous because dyes generally harbor a distinct allergization potential. In addition, there are large groups of people who exhibit demonstrable allergic reactions against a multitude of dyes. In order to lower the allergization potential, it is therefore advantageous to minimize the dye content in the inventive compositions, at best to the extent of freedom from dyes. Should dyes be desired, for example for visual reasons, the customary colorants, for example pigments, but preferably organic dyes are used. Organic dyes are found to be more skin-compatible in the context of the invention. The colorant content is preferably below 0.002% by weight of the composition, and is in particular 0% by weight.

In a preferred embodiment, the textile treatment composition is in solid, dispersed, pulverulent, pressed or granular form, but preferably in liquid form, in particular emulsified.

In a further embodiment, the textile treatment composition is in nonaqueous form. In the context of this invention, nonaqueous form is understood to mean water contents below 15% by weight based on the composition, preferably water contents below 10% by weight, more preferably below 8% by weight, preference among these being given in turn to water contents below 6% by weight, but preference is given in particular to water contents between 2 and 0.001% by weight based on the composition.

The advantage of a reduction in the water content in the composition is that the ingredients of the textile treatment composition can be used in the application in concentrated and thus more effective form, and also that the compositions have better processibility, for example emulsifiability.

In a further preferred embodiment, the textile treatment compositions do not comprise any additional fragrances or perfume oils. This is particularly advantageous since most of these fragrances or perfume oils, unless they are skin-healing and/or skin-protecting active substances in the context of the invention, have an allergization potential which impairs the present invention. In addition, there are large groups of people who exhibit clearly demonstrable allergic reactions against a multitude of such fragrances and/or perfume oils.

Although the inventive compositions are preferably free of the aforementioned odorants, it may be desired to generate a particularly pleasing fragrance note which cannot be generated from the inventive skin-healing active substances and their inherent fragrances alone. It is therefore possible in a preferred embodiment to add to the compositions in question a small amount of such odorants which are not skin-healing and/or skin-protecting active substances in the context of the invention. It should be ensured in this context that these additional odorants do not cause any allergic reactions.

The usual fragrances, odorants and/or perfume oils include, for example, the synthetic products of the ester, ether, aldehyde, ketone, alcohol and hydrocarbon type. Odorant compounds of the ester type are, for example, benzyl acetate, phenoxyethyl isobutyrate, p-tert-butylcyclohexyl acetate, linalyl acetate, dimethylbenzylcarbinyl acetate, phenylethyl acetate, linalyl benzoate, benzyl formate, ethyl methyl phenylglycinate, allyl cyclohexylpropionate, styrallyl propionate and benzyl salicylate. The ethers include, for example, benzyl ethyl ether; the aldehydes include, for example, the linear alkanals having 8-18 carbon atoms, citral, citronellal, citronellyloxyacetaldehyde, cyclamen aldehyde, hydroxycitronellal, lilial and bourgeonal; the ketones include, for example, the ionones, α-isomethylionone and methyl cedryl ketone; the alcohols include anethole, citronellol, eugenol, geraniol, linalool, phenylethyl alcohol and terpineol; the hydrocarbons include primarily the terpenes such as limonene and pinene. Perfume oils may also comprise natural odorant mixtures, as are obtainable from vegetable sources, for example pine oil, muscatel, clove oil, cinnamon leaf oil, lime blossom oil, juniperberry oil, vetiver oil, galbanum oil and labdanum oil, and also orange blossom oil, orange peel oil. However, these latter oils are not skin-healing and/or skin-protecting oils in the context of the invention.

In a particularly preferred embodiment, the textile treatment composition is an aftertreatment composition, preferably an after-rinse composition.

Aftertreatment composition is understood to mean compositions which are used only after the actual textile cleaning for a subsequent textile treatment. After-rinse compositions are quite generally understood to mean those compositions which are added to the liquor only after the actual textile cleaning and are preferably applied in an acidic medium. Such after-rinse compositions thus usually only reach the liquor after the last rinse cycle in order not to be removed with the actual wash liquor without being left behind or developing any action in the course of rinsing. Appropriate application of an after-rinse composition can be accomplished manually, i.e. by subsequent manual addition of the after-rinse composition as a separate composition. However, appropriate application can also be accomplished by means of a controlled-release mechanism. In this context, a controlled-release mechanism means the time-controlled release of active substances. Such control of active substance release can be controlled by means of various parameters. For example, it is possible to coat the active substances in question with a sensitive material, preferably with mixtures of polyvinyl alcohol and cellulose ether (methylhydroxycellulose, methylcellulose, methylhydroxypropylcellulose, hydroxypropylcellulose, hydroxyethylcellulose).

In this case, the characteristic dissolution behavior in each case of the coating material as a function of certain parameters is utilized. The dissolution behavior may be a function of time, of temperature, of pH, of ionic strength, of mechanical stress or corresponding parameters. In the case of the application of an after-rinse composition, it is, for example, appropriate to select a pH-sensitive but thermally robust coating material. In this way, the after-rinse composition can, on completion of the wash cycle, be released by shifting the pH from the alkaline into the acidic range, so that the coating material dissolves.

To perform the invention, laundry or textiles of any type is/are treated with an appropriate textile treatment composition in such a way that the particular textile comes into contact at least briefly or partly with the textile treatment composition. Such contact may be made in the course of usual laundry treatment, for example in the course of machine washing, of fabric softening, of handwashing, of machine drying. Preference is given to using the textile treatment composition as an aftertreatment composition, i.e. it can be introduced into the washing machine as an after-rinse composition after the wash, it can be introduced into the laundry dryer in the form of a conditioning substrate, or else the textiles which have already been washed and dried fully can be aftertreated individually. For the separate treatment of individual textiles, a variety of methods can be employed, for example spraying by the use of a spray applicator or the introduction of the textile into an appropriate treatment bath. It is also possible to apply the textile treatment composition by spray application or vapor application in the course of ironing. It is merely necessary to make contact of the textile treatment composition with the textile in one way or another, so that the textile treatment composition is enabled to remain at least partly on the textile after the application.

In a preferred embodiment, the inventive compositions are appropriate for their purpose especially when the substances mentioned in the embodiments remain at least partly on the textile after the textile treatment and, on contact of the skin with the textile, are released partly to the skin. It is crucial merely that the substances mentioned are transferred to the skin at least in traces on textile/skin contact. A further preferred embodiment of this invention is consequently that of textile treatment compositions which feature the transfer of the skin-healing and/or skin-protecting active substance to the textile in the course of textile treatment with such a composition, which remains at least partly on the textile and is at least partly released back to the skin by the textile when the textile comes into contact with the skin.

The fact that the skin-healing and/or skin-protecting substance in the inventive context remains partly on the textile fiber is to be regarded as advantageous for two reasons.

One is that there are sometimes dermatological problems as a result of direct skin incompatibility of certain fiber genera. As a result of the fact that the skin-healing substance remains partly on the textile, there is a reduction in the contact between fiber and bare skin, so that the skin-healing substance can be understood to be a fiber coating in the widest sense.

Secondly, modern laundry detergents have enabled outstanding visual cleaning effects to be achieved even at relatively low washing temperatures. As a result of the reduction in the washing temperature, it can be assumed that certain microorganisms detrimental to the natural skin flora of the human, which are killed at higher temperatures, now survive the wash cycle. The antiseptic constituents of the skin-healing substance on the fibers counteract this problem.

In a preferred embodiment, the inventive compositions additionally comprise urea and/or derivatives thereof. Urea and/or its derivatives promote the health of the skin, since they can have antimicrobial action, bind water, alleviate pruritus, loosen skin flakes and smoothen skin, and also inhibit excess cell growth. Moreover, they can serve the skin as a moisturizing factor, i.e. they can help the skin to store moisture.

In a further preferred embodiment, the inventive compositions additionally comprise lactic acid and/or citric acid and/or salts thereof. These two skin-friendly acids and/or salts thereof serve, inter alia, to sustain and to renew the natural acid protective mantle and hydrolipid film of the skin. The hydrolipid film of the skin is attacked or destroyed by alkaline influences, which results in a loss of the barrier function of the skin, so that microorganisms or harmful substances can penetrate more easily into the skin. The lactic and/or citric acid in the inventive compositions can, for example, remove residual alkali from the clothing and adjust the pH of the textiles to a pH range around 5. The additional lactic acid, which is a constituent of the epidermis in any case, has an additional stabilizing action on the acidic pH of the skin (pH approx. 5.2) and serves as a moisturizing factor, since it can improve the water binding capacity of the skin. Moreover, the lactic acid has a skin-smoothing action and supports the detachment of skin flakes.

In a further embodiment, the pH of the textile treatment composition is between 4-6.5, measured at a temperature of 20° C., in particular on a 1% aqueous solution of the textile treatment composition. This corresponds to the pH of the skin of a healthy human.

Since the surface of the skin is only weakly acidic (pH 5.5-6.5) in the region of the large sweat glands, for example in the genital region and in the armpits, there is precisely in these regions a reduced defense against germs or bacteria, so that it is particularly advantageous in the context of the invention when the pH of the textile treatment composition is not greater than pH 5.5, measured at a temperature of 20° C.

A further advantage of this pH range for the textile treatment composition can be seen in connection with body hygiene. When the body is washed with soap, the pH of the washed skin increases to about 9, so that the natural protective mantle of the skin is massively disrupted. By means of its self-regulating powers, the skin is capable of reestablishing the acidic pH. However, this process can take up to 3 hours, but generally at least 30 minutes. This differs from skin type to skin type and proceeds very slowly in infants, for example.

Such a pH range is particularly advantageous with regard to a group of people having particularly sensitive skin, such as babies or infants, or a group of people having already existing skin problems, for example allergy sufferers. For example, baby skin is considerably thinner than the skin of an adult human. Since the tallow production of baby skin is also distinctly reduced, it only has an incomplete barrier function and a very thin hydrolipid film. Here, there is a particular need for the inventive textile treatment compositions.

The advantage of the textile treatment composition having a pH as described above lies in the capability of textiles treated therewith to sustain the self-regulating powers of the skin as far as their alkali neutralization capacity is concerned, by virtue of the textile which comes into contact with the skin, for example a drying towel or underwear having a skin-optimal pH.

In this way, the textile treatment composition or the laundry treated therewith sustains the natural skin flora of the human.

In addition to the particular moisturizing factors mentioned, the inventive compositions may, in a preferred embodiment, include further moisturizing factors, for example those which are selected from the following group: amino acids, chitosan or chitosan salts/derivatives, ethylene glycol, glucosamine, glycerol, diglycerol, triglycerol, uric acid, honey and hydrogenated honey, creatinine, cleavage products of collagen, lactitol, polyols and polyol derivatives (for example butylene glycol, erythritol, propylene glycol, 1,2,6-hexanetriol, polyethylene glycols such as PEG4, PEG-6, PEG-7, PEG-8, PEG-9, PEG-10, PEG-12, PEG-14, PEG-16, PEG-18, PEG-20), pyrrolidonecarboxylic acid, sugar and sugar derivatives (for example fructose, glucose, maltose, maltitol, mannitol, inositol, sorbitol, sorbitylsilanediol, sucrose, trehalose, xylose, xylitol, glucuronic acid and salts thereof), ethoxylated sorbitol (sorbeth-6, sorbeth-20, sorbeth-30, sorbeth40), hydrogenated starch hydrolyzates and mixtures of hydrogenated wheat protein and PEG-20 acetate copolymer, in particular panthenol.

In a preferred embodiment, the inventive textile treatment composition serves as a fabric softener. In this case, the compositions preferably comprise small amounts of quaternary ammonium compounds, for example ester quats, but the compositions preferably do not comprise any quaternary ammonium compounds, for example ester quats, as ingredients. Ester quats are quaternary ammonium compounds in which hydrophobic groups are joined by means of ester bonds to a quaternized di- or triethanolamine or an analogous compound. The advantage of substantial to full freedom from ester quats and freedom from quaternary ammonium compounds results from their principle of action. The characteristic softness achieved by use of quaternary ammonium compounds or ester quats arises from the attachment of these substances to the textile fibers. At the same time, however, this results under some circumstances in a reduction in the absorbency and the water uptake of the fibers. Human sweat can possibly no longer fully be transported away outward from the skin surface by the textile fibers, but rather remains, sometimes in the form of a wet film of sweat on the skin, which is detrimental to the health of the skin. An accumulation of moisture combined with body heat can lead readily to eczema or fungus formation or at least create an environment in which eczematous or fungal disorders can colonize more readily. When the content of quaternary ammonium compounds or ester quat content of the composition is reduced substantially to fully, the absorbency and the water uptake capacity are no longer reduced by these substances.

In a preferred embodiment, the textile treatment composition can, however, comprise nonionic textile softeners, for example silicone oils.

A particular advantage of the inventive textile treatment compositions lies in the fact that, in a preferred embodiment, in spite of substantial or absolute freedom from quaternary ammonium compounds or ester quats, they function as fabric softeners.

This can be attributed to the fact that some of the inventive ingredients of the textile treatment composition which have already been detailed or are yet to be detailed, for example various oils such as almond oil, hemp oil, citric acid and/or lactic acid, for example, have fiber-softening properties or else are active in such a way that textiles are softened.

In a further preferred embodiment, the inventive textile treatment composition comprises an easy-iron agent and/or crease-reduction agent, for example those that will be mentioned elsewhere in the course of the description. The advantage of this embodiment lies in the fact that the easy-iron and crease-reduction effect can lower the ironing time, so that the valuable ingredients of the inventive textile treatment composition are not exposed to excessively long thermal stress through the ironing, and thus retain their full effect.

In a further preferred embodiment, the textile treatment composition is fixed reversibly to a polymeric support, for example by means of adsorptive forces, optionally with the additional action of surfactants, so that delayed release of the healing active substances is enabled. This is particularly advantageous, since it is possible in this way to achieve even longer-lasting action which is of benefit in particular for consumers having particularly irritated skin. By virtue of the release of the healing substances continuously over a prolonged period to the skin, for example in a relatively low dosage, it becomes possible to intervene in a quite cautious, sustaining manner into the particularly sensitive equilibrium of the self-regulating powers of highly irritated skin. The action of the healing substances is so mild that, in spite of its effectiveness, it in no way overburdens the already highly irritated skin.

Particularly preferred polymeric substrates belong to the class of the silicic esters. However, they may also be all conceivable other substrates, with the sole provisos that they enable delayed release of active ingredient while not having any adverse or irritating influence on the skin when they are used in the context of this invention.

In a further preferred embodiment, the textile treatment composition comprises, in addition to the healing active substances, one or more deodorizing active ingredients.

In this context, it should be noted that many of the oils already mentioned by name as such likewise have a deodorizing action. The particular advantage of the addition of one or more deodorizing active ingredients to the inventive textile treatment composition is the fact that these active ingredients, together with the oils mentioned, bring about a particularly enhanced effect because it is synergistic with regard to the deodorizing effectiveness. In this context, only one facet of the mode of action consists of the masking of malodorous or unpleasant odors. In connection with the action of the composition on the skin, caused by the skin/treated textile contact, an additional effect occurs which is based on the synergistic interplay of the healing active substances in the context of the invention with the added deodorizing active ingredient and also the self-regulating powers, so that not merely the symptom of the foul odor, but also the cause of this odor is eliminated. The cause is generally bacteria which in varying numbers colonize the skin or the hair or pubic hair region. These bacteria can decompose proteins and fats, for example from body sweat, to malodorous sulfur compounds. These bacteria are effectively counteracted by the synergistic interaction of the factors mentioned.

At the same time, the self-regulating powers of the skin are stimulated and trained.

In a further preferred embodiment, the textile treatment composition comprises, in addition to the healing active substances, one or more deodorizing active ingredients.

In this context, it should be noted that many of the oils already mentioned by name as such likewise have a deodorizing action. The particular advantage of the addition of one or more deodorizing active ingredients to the inventive textile treatment composition is the fact that these active ingredients, together with the oils mentioned, bring about a particularly enhanced effect because it is synergistic with regard to the deodorizing effectiveness. In this context, only one facet of the mode of action consists of the masking of malodorous or unpleasant odors. In connection with the action of the composition on the skin, caused by the skin/treated textile contact, an additional effect occurs which is based on the synergistic interplay of the healing active substances in the context of the invention with the added deodorizing active ingredient and also the self-regulating powers, so that not merely the symptom of the foul odor, but also the cause of this odor is eliminated. The cause is generally bacteria which in varying numbers colonize the skin or the hair or pubic hair region. These bacteria can decompose proteins and fats, for example from body sweat, to malodorous sulfur compounds. These bacteria are effectively counteracted by the synergistic interaction of the factors mentioned.

At the same time, the self-regulating powers of the skin are stimulated and trained.

In a preferred embodiment, the textile treatment composition is in the form of a microemulsion. Emulsions are disperse systems of at least two immiscible liquids, one phase being in the form of fine droplets distributed in the other continuous phase. A distinction is drawn here between macro- and microemulsions, this invention encompassing both genera of emulsions. However, microemulsions are particularly advantageous.

One advantage of microemulsions is that active ingredients can be dispersed substantially more finely in the disperse phase than in the disperse phase of macroemulsions. A further advantage is that they are readily sprayable owing to their generally low viscosity a preferred embodiment, the textile treatment composition is present in the form of an emulsion, in particular in the form of a microemulsion. Emulsions are disperse systems of at least two immiscible liquids, one phase being in the form of fine droplets distributed in the other continuous phase. A distinction is drawn here between macro- and microemulsions, this invention encompassing both genera of emulsions. However, microemulsions are particularly advantageous.

One advantage of microemulsions is that active ingredients can be dispersed substantially more finely in the disperse phase than in the disperse phase of macroemulsions. A further advantage is that they are readily sprayable owing to their generally low viscosity.

An overview of the preparation and use of microemulsions is given by H. Eicke in SÖFW-Journal, 118, 311 (1992) and Th. Förster et al. in SÖFW-Journal, 122, 746 (1996).

The inventive emulsions are prepared by the classical procedures, for example by agitating, beating, stirring, turbulent mixing, injecting a liquid into another, by emulsification centrifusion, colloid mills, homogenizers, by vibrations and cavitation in the mixture, and many others. The emulsions can also form spontaneously from the components.

The emulsions may be stabilized with emulsifiers or stabilizers, so that possible creaming or sedimentation or the tendency of the dispersed particles to agglomerate is hindered. Such compounds commonly have amphiphilic character, i.e. have at least one polar group and one nonpolar group, although there may also be an excess of the apolar group, in which case they are referred to as coemulsifiers. The nonpolar groups used are generally saturated or unsaturated, branched or unbranched alkyl radicals, and also aryl or alkylaryl radicals. Polar end groups which occur are carboxylate, sulfonate, sulfate, phosphate, polyphosphate, lactate, citrate, tartrate, amine salts, quaternary ammonium compounds, betaines, alcohol, polyether, glycerol, sorbitol, pentaerythritol, sucrose, acetic acid, lactic acid radicals; groups which act as polar intermediate groups are hydroxyl, ester, sulfamide, amide, polyamide, polyamine, amine, ether, polyether, glycerol, sorbitol, pentaerythritol and sucrose groups, to name just a few. A distinction is drawn quite generally between anionic, cationic, amphoteric and zwitterionic emulsifiers, and also nonionic emulsifiers, and it is possible in principle in the context of this invention for all of these emulsifiers to be used, even those which do not fit into the aforementioned categories. However, in the context of this invention, it has to be ensured that the emulsifier is physiologically and toxicologically safe in the inventive use, which is consistent with the purpose of the invention, specifically to provide an advantage to the skin. Preference is given to using nonionic emulsifiers. It is also advantageously possible in accordance with the invention to use all conceivable and customary emulsifying assistants. It may equally be desirable that the inventive compositions, particularly when they have been emulsified, especially when they are spray-dispensed, optionally include penetration accelerants. These are substances which accelerate the penetration of the active substances from the textile into the skin. These are, for example, phenoxyethanol or phenylethanol.

The inventive textile treatment compositions in the form of such emulsions may be applied to the textile in various ways. In a preferred embodiment, the textile treatment composition is applied directly and immediately to the textile. This can be effected, for example, by spray application with the aid of a spray applicator or the like.

In a preferred embodiment, the inventive textile treatment composition is incorporated into a water-soluble package, preferably portioned in a single portion. In the context of the invention, single portion is understood to mean that amount of textile treatment composition which is required for a treatment operation, in particular for an after-rinse operation, especially in a machine. These single portions are each preferably incorporated into water-soluble packages. This has the advantage that the valuable ingredients of the composition are better protected from external influences.

In another embodiment, the textile treatment composition is present in tablet form which consists preferably of a plurality of separate phases. This has the advantage of easy meterability. The separation of the tablets into different phases or regions makes it possible to incorporate the valuable healing ingredients spatially separate from remaining active substances in one metering unit, so that no negative interaction can occur between individual ingredients. The aforementioned moldings preferably comprise disintegration systems which enable easy release of the active substances. Suitable disintegration systems are, in addition to the classical effervescent systems such as acid/carbonate, for example citric acid or citrate with sodium carbonate, also swelling polymers, for example finely divided cellulose and the like.

In a preferred embodiment, the inventive compositions comprise, in addition to the inventive skin-protecting and/or skin-healing substances, one or more additional substances which have an effect on the human organism, for example the respiratory organs and/or the human psyche. Such substances may of course also be skin-functional in the sense of the inventive attributes of skin-healing and/or skin-protecting, but need not be. Some of the substances already detailed, for example St. John's wort, lavandin, melissa, incense, have, for example, not only a skin-functional mode of action, but also have a calming or mood-enhancing effect on the human psyche. Through the olfactory bulb (Bulbus Olfactorius) in the nose, the essential oils of such substances pass into the limbic system of the brain. Here, the essential oils in some cases act without the essential oils having been registered beforehand by the sense of smell, since the active concentrations are often below the concentration at which they become perceptible by smell. In this respect, there exists a distinct delimitation from the classical odorants listed above, for whose purposes it is vital that they are registered by the sense of smell. However, the aim in this inventive context is not to generate a fragrance, but rather to generate certain effects on the human organism.

By the use of spray applicators which comprise the inventive textile treatment compositions, it is possible to functionalize items of clothing and other textiles which come into contact with the skin, ranging from hand towels through bed linen to handkerchiefs, by spraying. For the sustaining, mucus-loosening or cough-alleviating or decongestant treatment in the case of influenza, coughing or bronchitis or other disorders of this type, it is possible, for example, to apply to the pajama top or a handkerchief substances such as benzoin, eucalyptus, thyme, lime, mint, grapefruit, lemon, petitgrain, bergamot, citronella, mugo pine, peppermint, ysop or lavender. Thus, the healing of the respiratory passages and the bronchi can advantageously be promoted. For the sustaining treatment of difficulties in dropping off to sleep or nervous tension or even states of depression, it is possible to apply in the same way, for example, substances such as camilla, lavender, melissa, neroli, sandalwood, rose, geranium, incense.

It is equally possible to confirm the variety of possible uses by a more exotic example by applying, in an appropriate manner, eroticizing or aphrodisiac substances, for example vanilla, ylang-ylang, jasmine, musk, sandalwood, tonka bean, cinnamon rind. In all of these cases, absorption is by means of the respiratory passages and/or neural pathways.

It is equally possible to provide perfusion-promoting textile fabric by spraying with substances, for example mustard oil, gaultheria, laurel oil, rosemary oil, camphor, thyme, arnica, for example socks or gloves in the case of inadequate perfusion of the extremities. Here, absorption is by means of the respiratory passages and the skin.

In the context of the invention, it merely has to be ensured that at least one skin-friendly substance is likewise also transferred to the textile to be treated, so that it is transferred to the skin at least in traces on textile/skin contact.

In a similar manner, it is possible to provide textiles which enable sustaining treatment of skin diseases, for example counteract fungal skin infection (use of tea tree oil) or bodily dysfunctions, for example hyperhidrosis (use of sage). Here, there is an advantage in appropriately finishing certain items of clothing, for example socks, by means of a spray and thus ensuring localized application.

The invention accordingly further provides a product comprising an inventive textile treatment composition in liquid form, especially emulsified, and a spray dispenser.

The spray dispenser is preferably a manually activatable spray dispenser, in particular selected from the group comprising aerosol spray dispensers, self-pressurizing spray dispensers, pump spray dispensers and trigger spray dispensers, in particular pump spray dispensers and trigger spray dispensers having a container made of transparent polyethylene or polyethylene terephthalate.

Such or related application devices are standard commercial products, and all standard commercial spray dispensers or related application devices are useful for the inventive application.

The invention accordingly further provides a process for textile treatment, in which an effective amount of an inventive composition, preferably using a product just described, is applied to the textile to be treated, preferably by spraying. An effective amount is understood to mean an amount which enables the sustaining and promotion of the self-regulating powers of human skin in the above-described inventive sense. This amount is an individual amount which depends upon many factors, for example skin type, degree of damage to the skin, desired result or result to be achieved. It is crucial merely that the treated textile, on contact with the skin, can release inventive healing active substances thereto, at least in the trace region.

In a preferred embodiment of the process just mentioned, the inventive composition, especially using an inventive product, is sprayed onto and/or into the textile object or onto the textile surface, in particular from a distance of from 10 to 100 cm, preferably from 20 to 50 cm, more preferably from 25 to 40 cm, exceptionally preferably about 30 cm.

In a further embodiment, the inventive textile treatment compositions comprise one or more of all of those active substances which are disclosed in EP 0 789 070 A1, i.e. active substances from the groups of the waxes, of the hydrophobic plant extracts, of certain hydrocarbons, of higher fatty acids and esters, of essential oils, lipids, vitamins, sunscreens, phospholipids, derivatives of alpha-hydroxy acids and/or mixtures of aforementioned components, in each case to the extent specified there and above it, but at the same time do not comprise any quaternary ammonium compounds or other relevant textile-softening compounds. The absence of relevant textile-softening compounds is necessary in the connection just mentioned, since, firstly, the aim of the use of the inventive compositions is not classical textile softening, but rather to establish a new product class which, in the laundry detergent/cosmetic product/medical product triangle of action, has its emphasis in the medical products sector. Secondly, the above-detailed problems regarding quaternary ammonium compounds, for example reduction in the fiber absorbency, should be ruled out.

In a further preferred embodiment, the textile treatment compositions are surfactant-free.

The invention further relates to a laundry detergent, especially to a liquid laundry detergent consisting of at least two components. These components are at least one laundry detergent or cleaning composition component and at least one textile treatment component in the above-mentioned sense, which thus comprises one or more skin-protecting and/or skin-healing active substances, and these two components are preferably released at different times in a washing or textile treatment operation. The laundry detergent or cleaning composition component will preferably be released first, and the textile treatment component preferably not until a later time. The two components of the laundry detergent may be strictly spatially separated, for example in the form of two separate chambers or two bags. However, they may also be incorporated into one another, for example in the form of capsules which are disposed in a gel, a liquid, a powder or the like, or they are mixed or blended with one another. However, it is preferred that the textile treatment component in the textile treatment can be released in a time-delayed and controlled manner.

In the context of the present invention, laundry detergent or cleaning composition component is understood to mean formulations or components of all conceivable substances relevant in connection with a washing or cleaning operation. These are primarily the actual laundry detergents or cleaning compositions with their individual components illustrated in detail in the further course of the description. These include active substances such as surfactants (anionic, nonionic, cationic and amphoteric surfactants), builder substances (inorganic and organic builder substances), bleaches (for example peroxo bleaches and chlorine bleaches), bleach activators, bleach stabilizers, bleach catalysts, enzymes, especially polymers (for example those having cobuilder properties), graying inhibitors, without the term being restricted to these substance groups.

However, the term laundry detergent or cleaning composition component, should also be understood to mean laundry detergent and cleaning composition adjuvants. Examples of these are optical brighteners, UV-protective substances and soil repellants, i.e. polymers which counteract resoiling of fibers or hard surfaces.

When the inventive laundry detergent is a liquid laundry detergent, it consists of at least two components, specifically at least one laundry detergent or cleaning composition component, and at least one textile treatment component. Especially when the textile treatment component comprises an oil, the liquid laundry detergent is preferably in the form of an emulsion, in particular in the form of a microemulsion, which corresponds to a preferred embodiment. In the context of this invention, liquid laundry detergents is understood to mean textile cleaning compositions which are in liquid to gel form at 20° C. and can be used universally. These may be aqueous or else nonaqueous. Nonaqueous liquid laundry detergents in the context of this invention are liquid to gel-form textile cleaning compositions which preferably have a low water content and can preferably be packaged in portioned form in water-soluble coatings.

In their laundry detergent or cleaning composition component, the inventive laundry detergents may consequently optionally comprise one or more anionic surfactants.

The anionic surfactants used are, for example, those of the sulfonate and sulfate type. Useful surfactants of the sulfonate type are preferably C₉₋₁₃-alkylbenzenesulfonates, olefinsulfonates, i.e. mixtures of alkene- and hydroxyalkanesulfonates, and disulfonates, as are obtained, for example, from C₁₂₋₁₈-monoolefins with terminal or internal double bond by sulfonation with gaseous sulfur trioxide and subsequent alkaline or acidic hydrolysis of the sulfonation products. Also suitable are alkanesulfonates which are obtained from C₁₂₋₁₈-alkanes, for example by sulfochlorination or sulfoxidation with subsequent hydrolysis or neutralization. The esters of sulfo fatty acids (ester sulfonates), for example the sulfonated methyl esters of hydrogenated coconut, palm kernel or tallow fatty acids, are also likewise suitable.

Further suitable anionic surfactants are sulfated fatty acid glycerol esters. Fatty acid glycerol esters refer to the mono-, di- and triesters, and mixtures thereof, as are obtained in the preparation by esterification of a monoglycerol with from 1 to 3 mol of fatty acid or in the transesterification of triglycerides with from 0.3 to 2 mol of glycerol. Preferred sulfated fatty acid glycerol esters are the sulfation products of saturated fatty acids having from 6 to 22 carbon atoms, for example of caproic acid, caprylic acid, capric acid, myristic acid, lauric acid, palmitic acid, stearic acid or behenic acid.

Preferred alk(en)yl sulfates are the alkali metal and in particular the sodium salts of the sulfuric monoesters of C₁₂-C₁₈ fatty alcohols, for example of coconut fatty alcohol, tallow fatty alcohol, lauryl, myristyl, cetyl or stearyl alcohol, or of C₁₀-C₂₀ oxo alcohols and those monoesters of secondary alcohols of these chain lengths. Also preferred are alk(en)yl sulfates of the chain length mentioned which contain a synthetic straight-chain alkyl radical prepared on a petrochemical basis and which have analogous degradation behavior to the equivalent compounds based on fatty chemical raw materials. From the washing point of view, preference is given to the C₁₂-C₁₆-alkyl sulfates and C₁₂-C₁₅-alkyl sulfates, and C₁₄-C₁₅-alkyl sulfates. 2,3-Alkyl sulfates, which are prepared, for example, according to U.S. Pat. Nos. 3,234,258 or 5,075,041, and can be obtained as commercial products from the Shell Oil Company under the name DAN®, are also suitable anionic surfactants.

Also suitable are the sulfuric monoesters of the straight-chain or branched C₇₋₂₁-alcohols ethoxylated with 1 to 6 mol of ethylene oxide, such as 2-methyl-branched C₉₋₁₁-alcohols with on average 3.5 mol of ethylene oxide (EO) or C₁₂₋₁₈-fatty alcohols with from 1 to 4 EO. Owing to their high tendency to foam, they are used in cleaning compositions only in relatively small amounts, for example amounts of from 1 to 5% by weight.

Further suitable anionic surfactants are also the salts of alkylsulfosuccinic acid, which are also referred to as sulfosuccinates or as sulfosuccinic esters and are the monoesters and/or diesters of sulfosuccinic acid with alcohols, preferably fatty alcohols and in particular ethoxylated fatty alcohols. Preferred sulfosuccinates contain C₈₋₁₈ fatty alcohol radicals or mixtures thereof. Especially preferred sulfosuccinates contain a fatty alcohol radical which is derived from ethoxylated fatty alcohols which, considered alone, constitute nonionic surfactants. In this context, particular preference is in turn given to sulfosuccinates whose fatty alcohol radicals derive from ethoxylated fatty alcohols with a narrowed homolog distribution. It is also equally possible to use alk(en)ylsuccinic acid having preferably from 8 to 18 carbon atoms in the alk(en)yl chain or salts thereof.

Useful further anionic surfactants are in particular soaps. Suitable soaps are saturated fatty acid soaps, such as the salts of lauric acid, myristic acid, palmitic acid, stearic acid, hydrogenated erucic acid and behenic acid, and soap mixtures derived in particular from natural fatty acids, for example coconut, palm kernel or tallow fatty acids.

The anionic surfactants including the soaps may be present in the form of their sodium, potassium or ammonium salts, and also in the form of soluble salts of organic bases, such as mono-, di- or triethanolamine. The anionic surfactants are preferably present in the form of their sodium or potassium salts, in particular in the form of the sodium salts.

A further class of anionic surfactants is the class of ethercarboxylic acids obtainable by reaction of fatty alcohol ethoxylates with sodium chloroacetate in the presence of basic catalysts. They have the general formula: R¹O—(CH₂—CH₂—O)ₚ—CH₂—COOH where R¹═C₁-C₁₈ and p=from 0.1 to 20. Ethercarboxylic acids are water hardness-insensitive and have outstanding surfactant properties. Preparation and use are described, for example, in Seifen, Öle, Fette, Wachse 101, 37 (1975); 115, 235 (1989) and Tenside Deterg. 25, 308 (1988).

Suitable anionic surfactants are, for example, also the partial esters of di- or polyhydroxyalkanes, mono- and disaccharides, polyethylene glycols with the ene adducts of maleic anhydride to at least monounsaturated carboxylic acids having a chain length of from 10 to 25 carbon atoms, with an acid number of from 10 to 140, which are described in DE 38 08 114 A1 (Grillo-Werke) and EP 0 046 070 A (Grillo-Werke), to which reference is made in this regard and the contents of both are hereby incorporated into this application.

Preferred anionic surfactants have not only an unbranched or branched, saturated or unsaturated, aliphatic or aromatic, acyclic or cyclic, optionally alkoxylated alkyl radical having from 4 to 28, preferably from 6 to 20, in particular from 8 to 18, more preferably from 10 to 16, exceptionally preferably from 12 to 14, carbon atoms, but also two or more anionic, in particular two, acid groups, preferably carboxylate, sulfonate and/or sulfate groups, in particular one carboxylate and one sulfate group. Examples of these compounds are the sulfofatty acid salts, the acyl glutamates, the monoglyceride disulfates and the alkyl ethers of glyceryl disulfate, and in particular the monoesterified sulfosuccinates described below.

Particularly preferred anionic surfactants are the sulfosuccinates, sulfosuccinamates and sulfosuccinamides, in particular sulfosuccinates and sulfosuccinamates, exceptionally preferably sulfosuccinates. The sulfosuccinates are the salts of the mono- and diesters of sulfosuccinic acid HOOCCH(SO₃H)CH₂COOH, while the sulfosuccinamates refer to the salts of monoamides of sulfosuccinic acid and the sulfosuccinamides to the salts of diamides of sulfosuccinic acid. A comprehensive description of these known anionic surfactants is provided by A. Domsch and B. Irrgang in Anionic surfactants: organic chemistry (edited by H. W. Stache; Surfactant science series; volume 56; ISBN 0-8247-9394-3; Marcel Dekker, Inc., New York 1996, pp. 501-549).

The salts are preferably alkali metal salts, ammonium salts and also mono-, di- and trialkanolammonium salts, for example mono-, di- and triethanolammonium salts, in particular lithium, sodium, potassium or ammonium salts, more preferably sodium or ammonium salts, exceptionally preferably sodium salts.

In the sulfosuccinates, one or both carboxyl groups of sulfosuccinic acid has/have preferably been esterified with one or two identical or different, unbranched or branched, saturated or unsaturated, acyclic or cyclic, optionally alkoxylated alcohols having from 4 to 22, preferably from 6 to 20, in particular from 8 to 18, more preferably from 10 to 16, exceptionally preferably from 12 to 14, carbon atoms. Particular preference is given to the esters of unbranched and/or saturated and/or acyclic and/or alkoxylated alcohols, in particular unbranched, saturated fatty alcohols and/or unbranched, saturated fatty alcohols alkoxylated with ethylene oxide and/or propylene oxide, preferably ethylene oxide, and having a degree of alkoxylation of from 1 to 20, preferably from 1 to 15, in particular from 1 to 10, more preferably from 1 to 6, exceptionally preferably from 1 to 4. In the context of the present invention, the monoesters are preferred over the diesters. A particularly preferred sulfosuccinate is sulfosuccinic acid lauryl polyglycol ester disodium salt (lauryl-EO sulfosuccinate, disodium salt; INCI Disodium Laureth Sulfosuccinate), which is commercially available, for example, as Tego® Sulfosuccinat F 30 (Goldschmidt) having a sulfosuccinate content of 30% by weight.

In the sulfosuccinamates or sulfosuccinamides, one or both carboxyl groups of sulfosuccinic acid preferably form(s) a carboxamide with a primary or secondary amine which bears one or two identical or different, unbranched or branched, saturated or unsaturated, acyclic or cyclic, optionally alkoxylated alkyl radicals having from 4 to 22, preferably from 6 to 20, in particular from 8 to 18, more preferably from 10 to 16, exceptionally preferably from 12 to 14, carbon atoms. Particular preference is given to unbranched and/or saturated and/or acyclic alkyl radicals, in particular unbranched, saturated fatty alkyl radicals.

Also suitable are, for example, the following sulfosuccinates and sulfosuccinamates designated according to INCI, which are described in detail in the International Cosmetic Ingredient Dictionary and Handbook: Ammonium Dinonyl Sulfosuccinate, Ammonium Lauryl Sulfosuccinate, Diammonium Dimethicone Copolyol Sulfosuccinate, Diammonium Lauramido-MEA Sulfosuccinate, Diammonium Lauryl Sulfosuccinate, Diammonium Oleamido PEG-2 Sulfosuccinate, Diamyl Sodium Sulfosuccinate, Dicapryl Sodium Sulfosuccinate, Dicyclohexyl Sodium Sulfosuccinate, Diheptyl Sodium Sulfosuccinate, Dihexyl Sodium Sulfosuccinate, Diisobutyl Sodium Sulfosuccinate, Dioctyl Sodium Sulfosuccinate, Disodium Cetearyl Sulfosuccinate, Disodium Cocamido MEA-Sulfosuccinate, Disodium Cocamido MIPA-Sulfosuccinate, Disodium Cocamido PEG-3 Sulfosuccinate, Disodium Coco-Glucoside Sulfosuccinate, Disodium Cocoyl Butyl Gluceth-10 Sulfosuccinate, Disodium C12-15 Pareth Sulfosuccinate, Disodium Deceth-5 Sulfosuccinate, Disodium Deceth-6 Sulfosuccinate, Disodium Dihydroxyethyl Sulfosuccinylundecylenate, Disodium Dimethicone Copolyol Sulfosuccinate, Disodium Hydrogenated Cottonseed Glyceride Sulfosuccinate, Disodium Isodecyl Sulfosuccinate, Disodium Isostearamido MEA-Sulfosuccinate, Disodium Isostearamido MIPA-Sulfosuccinate, Disodium Isostearyl Sulfosuccinate, Disodium Laneth-5 Sulfosuccinate, Disodium Lauramido MEA-Sulfosuccinate, Disodium Lauramido PEG-2 Sulfosuccinate, Disodium Lauramido PEG-5 Sulfosuccinate, Disodium Laureth-6 Sulfosuccinate, Disodium Laureth-9 Sulfosuccinate, Disodium Laureth-12 Sulfosuccinate, Disodium Lauryl Sulfosuccinate, Disodium Myristamido MEA-Sulfosuccinate, Disodium Nonoxynol-10 Sulfosuccinate, Disodium Oleamido MEA-Sulfosuccinate, Disodium Oleamido MIPA-Sulfosuccinate, Disodium Oleamido PEG-2 Sulfosuccinate, Disodium Oleth-3 Sulfosuccinate, Disodium Oleyl Sulfosuccinate, Disodium Palmitamido PEG-2 Sulfosuccinate, Disodium Palmitoleamido PEG-2 Sulfosuccinate, Disodium PEG-4 Cocamido MIPA-Sulfosuccinate, Disodium PEG-5 Laurylcitrate Sulfosuccinate, Disodium PEG-8 Palm Glycerides Sulfosuccinate, Disodium Ricinoleamido MEA-Sulfosuccinate, Disodium Sitostereth-14 Sulfosuccinate, Disodium Stearamido MEA-Sulfosuccinate, Disodium Stearyl Sulfosuccinamate, Disodium Stearyl Sulfosuccinate, Disodium Tallamido MEA-Sulfosuccinate, Disodium Tallowamido MEA-Sulfosuccinate, Disodium Tallow Sulfosuccinamate, Disodium Tridecylsulfosuccinate, Disodium Undecylenamido MEA-Sulfosuccinate, Disodium Undecylenamido PEG-2 Sulfosuccinate, Disodium Wheat Germamido MEA-Sulfosuccinate, Disodium Wheat Germamido PEG-2 Sulfosuccinate, Di-TEA-Oleamido PEG-2 Sulfosuccinate, Ditridecyl Sodium Sulfosuccinate, Sodium Bisglycol Ricinosulfosuccinate, Sodium/MEA Laureth-2 Sulfosuccinate and Tetrasodium Dicarboxyethyl Stearyl Sulfosuccinamate. Yet another suitable sulfosuccinamate is disodium C₁₆₋₁₈-alkoxypropylene sulfosuccinamate.

In a preferred embodiment, the inventive laundry detergent comprises, in its laundry detergent or cleaning composition component, one or more sulfosuccinates, sulfosuccinamates and/or sulfosuccinamides, preferably sulfosuccinates and/or sulfosuccinamates, in particular sulfosuccinates, in an amount of typically from 0.05 to 15% by weight, preferably from 0.1 to 10% by weight, in particular from 0.3 to 6% by weight, more preferably from 0.5 to 3% by weight, exceptionally preferably from 0.7 to 2% by weight, for example 0.75 or 1.5% by weight.

As a further component, the inventive laundry detergents may comprise, in their laundry detergent or cleaning composition component, optionally one or more nonionic surfactants.

The nonionic surfactants used are preferably alkoxylated, advantageously ethoxylated and/or propoxylated, especially primary alcohols having preferably from 8 to 18 carbon atoms and on average from 1 to 12 mol of ethylene oxide (EO) and/or from 1 to 10 mol of propylene oxide (PO) per mole of alcohol. Particular preference is given to C₈-C₁₆-alcohol alkoxylates, advantageously ethoxylated and/or propoxylated C₁₀-C₁₅-alcohol alkoxylates, in particular C₁₂-C₁₄-alcohol alkoxylates, having a degree of ethoxylation between 2 and 10, preferably between 3 and 8, and/or a degree of propoxylation between 1 and 6, preferably between 1.5 and 5. The alcohol radical may preferably be linear or more preferably 2-methyl-branched, or may contain a mixture of linear and methyl-branched radicals, as are typically present in oxo alcohol radicals. However, especially preferred alcohol ethoxylates have linear radicals from alcohols of native origin which have from 12 to 18 carbon atoms, for example from coconut, palm, tallow fat or oleyl alcohol, and on average from 2 to 8 EO per mole of alcohol. The preferred ethoxylated alcohols include, for example, C₁₂₋₁₄-alcohols having 3 EO or 4 EO, C₉₋₁₁-alcohol having 7 EO, C₁₃₋₁₅-alcohols having 3 EO, 5 EO, 7 EO or 8 EO, C₁₂₋₁₈-alcohols having 3 EO, 5 EO or 7 EO, and mixtures thereof, such as mixtures of C₁₂₋₁₄-alcohol having 3 EO and C₁₂₋₁₈-alcohol having 5 EO. The degrees of ethoxylation and propoxylation specified constitute statistical average values which may be an integer or a fraction for a specific product. Preferred alcohol ethoxylates and propoxylates have a narrowed homolog distribution (narrow range ethoxylates/propoxylates, NRE/NRP). In addition to these nonionic surfactants, it is also possible to use fatty alcohols having more than 12 EO. Examples thereof are tallow fat alcohol having 14 EO, 25 EO, 30 EO or 40 EO.

Also suitable are alkoxylated amines, advantageously ethoxylated and/or propoxylated, especially primary and secondary amines having preferably from 1 to 18 carbon atoms per alkyl chain and on average from 1 to 12 mol of ethylene oxide (EO) and/or from 1 to 10 mol of propylene oxide (PO) per mole of amine.

In addition, further nonionic surfactants which may be used are also alkyl glycosides of the general formula RO(G)ₓ, for example in the form of compounds, particularly with anionic surfactants, in which R is a primary straight-chain or methyl-branched, in particular 2-methyl-branched, aliphatic radical having from 8 to 22, preferably from 12 to 18, carbon atoms and G is the symbol which represents a glycose unit having 5 or 6 carbon atoms, preferably glucose. The degree of oligomerization x, which specifies the distribution of monoglycosides and oligoglycosides, is any number between 1 and 10; x is preferably from 1.2 to 1.4.

A further class of nonionic surfactants used with preference, which are used either as the sole nonionic surfactant or in combination with other nonionic surfactants, is that of alkoxylated, preferably ethoxylated or ethoxylated and propoxylated, fatty acid alkyl esters, preferably having from 1 to 4 carbon atoms in the alkyl chain, in particular fatty acid methyl esters, as are described, for example, in the Japanese patent application JP 58/217598 or which are prepared preferably by the process described in the international patent application WO-A-90/13533.

Nonionic surfactants of the amine oxide type, for example N-cocoalkyl-N,N-dimethylamine oxide and N-(tallow alkyl)-N,N-dihydroxyethylamine oxide, and of the fatty acid alkanolamide type may also be suitable.

Further useful surfactants are what are known as gemini surfactants. These generally refer to those compounds which have two hydrophilic groups and two hydrophobic groups per molecule. These groups are generally separated from each other by a spacer. This spacer is generally a carbon chain which should be sufficiently long that the hydrophilic groups have adequate separation so that they can act independently of one another. Such surfactants generally feature an unusually low critical micelle concentration and the ability to greatly reduce the surface tension of water. However, the term gemini surfactants refers in exceptional cases not only to dimeric, but also to trimeric surfactants.

Suitable gemini surfactants are, for example, sulfated mixed hydroxy ethers according to the German patent application DE-A-43 21 022 or dimer alcohol bis- and trimer alcohol trissulfates and ether sulfates according to the international patent application WO-A-96/23768. End group-capped dimeric and trimeric mixed ethers according to the German patent application DE-A-195 13 391 have the particular feature of their bi- and multi-functionality. For instance, the end group-capped surfactants mentioned have good wetting properties and are low-foaming, so that they are especially suitable for use in machine washing or cleaning processes.

However, it is also possible to use gemini polyhydroxy fatty acid amides or poly(polyhydroxy fatty acid amides), as described in the international patent applications WO-A-95/19953, WO-A-95/19954 and WO-A-95/19955.

Further suitable surfactants are polyhydroxy fatty acid amides of the following formula 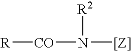
in which RCO is an aliphatic acyl radical having from 6 to 22 carbon atoms, R² is hydrogen, an alkyl or hydroxyalkyl radical having from 1 to 4 carbon atoms and [Z] is a linear or branched polyhydroxyalkyl radical having from 3 to 10 carbon atoms and from 3 to 10 hydroxyl groups. The polyhydroxy fatty acid amides are known substances which can typically be obtained by reductively aminating a reducing sugar with ammonia, an alkylamine or an alkanolamine, and subsequently acylating with a fatty acid, a fatty acid alkyl ester or a fatty acid chloride.

The group of polyhydroxy fatty acid amides also includes compounds of the following formula 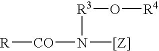
in which R is a linear or branched alkyl or alkenyl radical having from 7 to 12 carbon atoms, R³ is a linear, branched or cyclic alkyl radical or an aryl radical having from 2 to 8 carbon atoms and R⁴ is a linear, branched or cyclic alkyl radical or an aryl radical or an oxyalkyl radical having from 1 to 8 carbon atoms, preference being given to C₁₋₄-alkyl or phenyl radicals, and [Z] is a linear polyhydroxyalkyl radical whose alkyl chain is substituted by at least two hydroxyl groups, or alkoxylated, preferably ethoxylated or propoxylated, derivatives of this radical.

[Z] is preferably obtained by reductive amination of a reduced sugar, for example glucose, fructose, maltose, lactose, galactose, mannose or xylose. The N-alkoxy- or N-aryloxy-substituted compounds can then, for example according to the teaching of international application WO-A-95/07331, be converted to the desired polyhydroxy fatty acid amides by reaction with fatty acid methyl esters in the presence of an alkoxide as catalyst.

Preferred nonionic surfactants are one or more unbranched or branched, saturated or unsaturated C₁₀₋₂₂-alcohols which have been alkoxylated with ethylene oxide (EO) and/or propylene oxide (PO) and have a degree of alkoxylation of up to 30, preferably ethoxylated C₁₀₋₁₈ fatty alcohols having a degree of ethoxylation of less than 30, preferably from 1 to 20, in particular from 1 to 12, more preferably from 1 to 8, exceptionally preferably from 2 to 5, for example C₁₂₋₁₄ fatty alcohol ethoxylates having 2, 3 or 4 EO, or a mixture of the C₁₂₋₁₄ fatty alcohol ethoxylates having 3 and 4 EO in a weight ratio of 1 to 1, or isotridecyl alcohol ethoxylate having 5, 8 or 12 EO, as described, for example, in DE 40 14 055 C2 (Grillo-Werke), which is incorporated by reference in this respect and whose contents are hereby incorporated into this application.

The nonionic surfactants may typically be present in amounts of up to 50% by weight, preferably from 0.1 to 40% by weight, more preferably from 0.5 to 30% by weight and in particular from 2 to 25% by weight, based in each case on the overall composition.

In addition, the inventive laundry detergents may optionally comprise amphoteric surfactants. In addition to numerous mono- to trialkylated amine oxides, the betaines are an important class.

Betaines are known surfactants which are prepared predominantly by carboxyalkylation, preferably carboxymethylation, of aminic compounds. Preference is given to condensing the starting materials with halocarboxylic acids or salts thereof, in particular with sodium chloracetate, to form one mole of salt per mole of betaine. In addition, it is also possible to add on unsaturated carboxylic acids, for example acrylic acid. For the nomenclature and in particular for the distinction between betaines and “true” amphosurfactants, reference is made to the article of U. Ploog in Seifen-Öle-Fette-Wachse, 108, 373 (1982). Further reviews on this theme can be found, for example, in A. O'Lennick et al. in HAPPI, November 70 (1986), S. Holzman et al. in Tens. Surf. Det. 23, 309 (1986), R. Bibo et al. in Soap Cosm. Chem. Spec., April 46 (1990) and P. Ellis et al. in Euro Cosm. 1, 14 (1994). Examples of suitable betaines are the carboxyalkylation products of secondary and especially tertiary amines, which follow the following formula 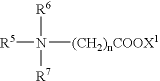
in which R⁵ is alkyl and/or alkenyl radicals having from 6 to 22 carbon atoms, R⁶ is hydrogen or alkyl radicals having from 1 to 4 carbon atoms, R⁷ is alkyl radicals having from 1 to 4 carbon atoms, n is from 1 to 6 and X¹ is an alkali and/or alkaline earth metal or ammonium. Typical examples are the carboxymethylation products of hexylmethylamine, hexyldimethylamine, octyldimethylamine, decyldimethylamine, dodecylmethylamine, dodecyldimethylamine, dodecylethylmethylamine, C_{12/14}-cocoalkyldimethylamine, myristyldimethylamine, cetyldimethylamine, stearyldimethylamine, stearylethylmethylamine, oleyldimethylamine, (C_{16/18} tallow alkyl)dimethylamine and their technical-grade mixtures.

Also useful are carboxyalkylation products of amido amines, which follow the following formula 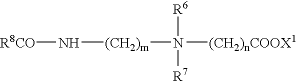
in which R⁸CO is an aliphatic acyl radical having from 6 to 22 carbon atoms and 0 or from 1 to 3 double bond(s), m is from 1 to 3, and R⁶, R⁷, n and X¹ are each as defined above. Typical examples are reaction products of fatty acids having from 6 to 22 carbon atoms, namely caproic acid, caprylic acid, capric acid, lauric acid, myristic acid, palmitic acid, palmitoleic acid, stearic acid, isostearic acid, oleic acid, elaidic acid, petroselic acid, linoleic acid, linolenic acid, elaeostearic acid, arachic acid, gadoleic acid, behenic acid and erucic acid and their technical-grade mixtures, with N,N-dimethylaminoethylamine, N,N-dimethylaminopropylamine, N,N-diethylaminoethylamine and N,N-diethylaminopropylamine, which have been condensed with sodium chloroacetate. Preference is given to using a condensation product of C_{8/18} coconut fatty acid N,N-dimethylaminopropylamide with sodium chloroacetate.

Further suitable starting materials for the betaines to be used in the context of the invention are also imidazolines which follow the following formula 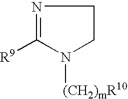
in which R⁹ is an alkyl radical having from 5 to 21 carbon atoms, R¹⁰ is a hydroxyl group, an OCOR⁹ or NHCOR⁹ radical, and m is 2 or 3. These substances too are known substances which can be obtained, for example, by cyclizing condensation of 1 or 2 mol of fatty acid with polyfunctional amines, for example aminoethylethanolamine (AEEA) or diethylenetriamine. The corresponding carboxyalkylation products are mixtures of different open-chain betaines. Typical examples are condensation products of the above-mentioned fatty acids with AEEA, preferably imidazolines based on lauric acid or again C_{12/14} coconut fatty acid, which are subsequently betainized with sodium chloroacetate.

In a preferred embodiment, the inventive laundry detergents are in liquid form. To achieve a liquid consistency, it may be appropriate to use either liquid organic solvents or water. The inventive compositions therefore optionally comprise solvents.

The inventive laundry detergents may advantageously also comprise cationic surfactants, preferably quaternary ammonium compounds, especially those which are biodegradable. Advantageously, cationic polymers may also be present.

Solvents which may be used in the inventive compositions stem, for example, from the group of mono- or polyhydric alcohols, alkanolamines or glycol ethers, as long as they are miscible with water in the concentration range specified. The solvents are preferably selected from ethanol, n- or i-propanol, butanols, glycol, propane- or butanediol, glycerol, diglycol, propyl- or butyldiglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl, ethyl or propyl ether, butoxypropoxypropanol (BPP), dipropylene glycol monomethyl or monoethyl ether, diisopropylene glycol monomethyl or monoethyl ether, methoxy-, ethoxy- or butoxytriglycol, 1-butoxyethoxy-2-propanol, 3-methyl-3-methoxybutanol, propylene glycol t-butyl ether, and mixtures of these solvents.

Some glycol ethers are obtainable under the trade names Arcosolv® (Arco Chemical Co.) or Cellosolve®, Carbitol® or Propasol® (Union Carbide Corp.); these also include, for example, ButylCarbitol®, HexylCarbitol®, MethylCarbitol® and Carbitol® itself, (2-(2-ethoxy)ethoxy)ethanol. The selection of the glycol ether can be made readily by those skilled in the art on the basis of its volatility, water solubility, its percentage by weight in the overall dispersion and the like. Pyrrolidone solvents such as N-alkylpyrrolidones, for example N-methyl-2-pyrrolidone or N—C₈-C₁₂-alkylpyrrolidone, or 2-pyrrolidone may likewise be used. Also preferred as the sole solvent or as a constituent of a solvent mixture are glycerol derivatives, in particular glyceryl carbonate.

The alcohols which may be used as cosolvents in the present invention include liquid polyethylene glycols having a lower molecular weight, for example polyethylene glycols having a molecular weight of 200, 300, 400 or 600. Further suitable cosolvents are other alcohols, for example (a) lower alcohols such as ethanol, propanol, isopropanol and n-butanol, (b) ketones such as acetone and methyl ethyl ketone, (c) C₂-C₄-polyols such as a diol or a triol, for example ethylene glycol, propylene glycol, glycerol or mixtures thereof. Especially preferred among the class of the diols is 1,2-octanediol.

In a preferred embodiment, the laundry detergent comprises one or more solvents from the group comprising C₁ to C₄ monoalcohols, C₂ to C₆ glycols, C₃ to C₁₂ glycol ethers and glycerol, in particular ethanol. The inventive C₃ to C₁₂ glycol ethers contain alkyl or alkenyl groups having fewer than 10 carbon atoms, preferably up to 8, in particular up to 6, more preferably from 1 to 4 and exceptionally preferably from 2 to 3, carbon atoms.

Preferred C₁ to C₄ monoalcohols are ethanol, n-propanol, isopropanol and tert-butanol. Preferred C₂ to C₆ glycols are ethylene glycol, 1,2-propylene glycol, 1,3-propylene glycol, 1,5-pentanediol, neopentyl glycol and 1,6-hexanediol, in particular ethylene glycol and 1,2-propylene glycol. Preferred C₃ to C₁₂ glycol ethers are di-, tri-, tetra- and pentaethylene glycol, di-, tri- and tetrapropylene glycol, propylene glycol mono-tert-butyl ether and propylene glycol monoethyl ether, and also the solvents designated according to INCI Butoxydiglycol, Butoxyethanol, Butoxyisopropanol, Butoxypropanol, Butyloctanol, Ethoxydiglycol, Ethoxyhanol, Ethyl Hexanediol, Isobutoxypropanol, Isopentyldiol, 3-Methoxybutanol, Methoxyethanol, Methoxyisopropanol and Methoxymethylbutanol.

The inventive laundry detergent may contain one or more solvents in an amount of typically up to 40% by weight, preferably from 0.1 to 30% by weight, in particular from 2 to 20% by weight, more preferably from 3 to 15% by weight, exceptionally preferably from 5 to 12% by weight, for example 5.3 or 10.6% by weight, based in each case on the overall composition.

In a preferred embodiment, the inventive laundry detergent optionally contains water in an amount of more than 50% by weight, in particular from 60 to 95% by weight, more preferably from 70 to 93% by weight and exceptionally preferably from 80 to 90% by weight.

In addition, the inventive laundry detergent may comprise, in the laundry detergent or cleaning composition component, one or more customary adjuvants and additives, in particular selected from the group of the builders, enzymes, bleaches, bleach activators, electrolytes, colorants, odorants, pH modifiers, complexing agents, fluorescors, foam inhibitors, graying inhibitors, anticrease agents, antioxidants, antistats, ironing aids, UV absorbers, optical brighteners, antiredeposition agents, germicides, viscosity regulators, pearlescents, dye transfer inhibitors, shrink preventers, corrosion inhibitors, preservatives, hydrophobizing and impregnating agents, hydrotropes, silicone oils, and antiswell and antislip agents, and also quaternary ammonium compounds, optionally with ester bonds.

In addition to the washing substances, builders are the most important ingredients of laundry detergents and cleaning compositions. The inventive laundry detergents may comprise, in the laundry detergent or cleaning composition component, builders used customarily in laundry detergents, rinsing compositions and cleaning compositions, i.e. in particular zeolites, silicates, carbonates, organic cobuilders and, where no ecological objections to their use exist, also the phosphates.

Suitable crystalline, sheet-type sodium silicates have the general formula NaMSiₓO₂ₓ₊₁≠H₂O where M is sodium or hydrogen, x is from 1.9 to 4, y is from 0 to 20, and preferred values for x are 2, 3 or 4. Such crystalline sheet silicates are described, for example, in the European patent application EP-A-0 164 514. Preferred crystalline sheet silicates of the formula specified are those in which M is sodium and x assumes the values of 2 or 3. In particular, preference is given to both β- and also δ-sodium disilicates Na₂Si₂O₅≠yH₂O, β-sodium disilicate being obtainable, for example, by the process which is described in the international patent application WO-A-91/08171.

It is also possible to use amorphous sodium silicates having an Na₂O:SiO₂ modulus of from 1:2 to 1:3.3, preferably from 1:2 to 1:2.8 and in particular from 1:2 to 1:2.6, which have retarded dissolution and secondary washing properties. The retardation of dissolution relative to conventional amorphous sodium silicates may have been brought about in a variety of ways, for example by surface treatment, compounding, compacting or by overdrying. In the context of this invention, the term morphous is also understood to mean X-ray-amorphous This means that, in X-ray diffraction experiments, the silicates do not afford any sharp X-ray reflections, as are typical of crystalline substances, but rather yield at best one or more maxima of the scattered X-radiation, which have a width of several degree units of the diffraction angle. However, it may quite possibly lead to even particularly good builder properties when the silicate particles in electron diffraction experiments yield vague or even sharp diffraction maxima. This is to be interpreted such that the products have microcrystalline regions with a size of from 10 to several hundred nm, preference being given to values up to a maximum of 50 nm and in particular up to a maximum of 20 nm. Such X-ray-amorphous silicates, which likewise have retarded dissolution compared with conventional waterglasses, are described, for example, in the German patent application DE-A-44 00 024. Special preference is given to compacted amorphous silicates, compounded amorphous silicates and overdried X-ray-amorphous silicates.

An optionally used finely crystalline, synthetic, bound water-containing zeolite is preferably zeolite A and/or P. The P-type zeolite is more preferably Zeolite MAP (e.g. commercial product: Doucil A24 from Crosfield). Also suitable, however, are zeolite X, and mixtures of zeolites A, X and/or P. Also commercially available and usable with preference in the context of the present invention is, for example, a cocrystal of zeolite X and zeolite A (approx. 80% by weight of zeolite X), which is sold by CONDEA Augusta S.p.A. under the trade name VEGOBOND AX®. Suitable zeolites have a mean particle size of less than 10 μm (volume distribution; measurement method: Coulter Counter) and preferably contain from 18 to 22% by weight, in particular from 20 to 22% by weight, of bound water.

It is of course also possible to use the commonly known phosphates as builder substances, as long as such a use is not to be avoided for ecological reasons. Especially suitable are the sodium salts of the orthophosphates, of the pyrophosphates and especially of the tripolyphosphates.

Organic builder substances which can be used are, for example, the polycarboxylic acids usable in the form of their sodium salts, polycarboxylic acids referring to those carboxylic acids which bear more than one acid function. Examples of these are citric acid, adipic acid, succinic acid, glutaric acid, malic acid, tartaric acid, maleic acid, fumaric acid, sugar acids, aminocarboxylic acids, nitrilotriacetic acid (NTA), as long as such a use is not objectionable on ecological grounds, and mixtures thereof. Preferred salts are the salts of the polycarboxylic acids such as citric acid, adipic acid, succinic acid, glutaric acid, tartaric acid, sugar acids and mixtures thereof. The acids themselves may also be used. In addition to their builder action, the acids typically also have the property of an acidifying component and thus also serve to set a lower and milder pH of laundry detergent and cleaning composition portions in accordance with the invention. In this connection, particular mention should be made of citric acid, succinic acid, glutaric acid, adipic acid, gluconic acid and any mixtures thereof.

Also suitable as builders are polymeric polycarboxylates. These are, for example, the alkali metal salts of polyacrylic acid or of polymethacrylic acid, for example those having a relative molar mass of from 500 to 70 000 g/mol.

In the context of the present invention, the molar masses specified for polymeric polycarboxylates are weight-average molar masses M_{w} of the particular acid form, which have always been determined by means of gel-permeation chromatography (GPC) using a UV detector. The measurement was against an external polyacrylic acid standard which, owing to its structural similarity to the polymers under investigation, provides realistic molecular weight values. These figures deviate considerably from the molecular weight data when polystyrenesulfonic acids are used as the standard. The molar masses measured against polystyrene acids are generally distinctly higher than the molar masses specified in the context of the present invention.

Suitable polymers are in particular polyacrylates which preferably have a molar mass of from 2000 to 20 000 g/mol. Owing to their superior solubility, preference within this group may be given in turn to the short-chain polyacrylates which have molar masses of from 2000 to 10 000 g/mol and more preferably from 3000 to 5000 g/mol.

Also suitable are copolymeric polycarboxylates, especially those of acrylic acid with methacrylic acid and of acrylic acid or methacrylic acid with maleic acid. Copolymers which have been found to be particularly suitable are those of acrylic acid with maleic acid which contain from 50 to 90% by weight of acrylic acid and 50 to 10% by weight of maleic acid. Their relative molar mass, based on free acids, is generally from 2000 to 70 000 g/mol, preferably from 20 000 to 50 000 g/mol and in particular from 30 000 to 40 000 g/mol.

The (co)polymeric polycarboxylates can either be used in the form of powder or in the form of aqueous solution. The content in the inventive compositions of (co)polymeric polycarboxylates is preferably from 0.5 to 20% by weight, in particular from 3 to 10% by weight.

To improve the water solubility, the polymers may also contain allylsulfonic acids, as, for example, in EP-B 0 727 448, allyloxybenzenesulfonic acid and methallylsulfonic acid as monomers.

Also especially preferred are biodegradable polymers composed of more than two different monomer units, for example those which, according to DE-A 43 00 772, contain, as monomers, salts of acrylic acid or of maleic acid, and vinyl alcohol or vinyl alcohol derivatives, or, according to DE-C 42 21 381, those which contain, as monomers, salts of acrylic acid and of 2-alkylallylsulfonic acid, and sugar derivatives.

Further preferred copolymers are those which are described in the German patent applications DE-A 43 03 320 and DE-A 44 17 734, and preferably contain, as monomers, acrolein and acrylic acid/acrylic acid salts or acrolein and vinyl acetate.

Further preferred builder substances which should likewise be mentioned are polymeric aminodicarboxylic acids, salts thereof or precursor substances thereof.

Particular preference is given to polyaspartic acids or salts and derivatives thereof, of which it is disclosed in the German patent application DE-A 195 40 086 that, in addition to cobuilder properties, they also have bleach-stabilizing action.

Further suitable builder substances are polyacetals which can be obtained by reacting dialdehydes with polyolcarboxylic acids which have from 5 to 7 carbon atoms and at least 3 hydroxyl groups, as described, for example, in the European patent application EP-A 0 280 223. Preferred polyacetals are obtained from dialdehydes such as glyoxal, glutaraldehyde, terephthalaldehyde, and mixtures thereof, and from polyolcarboxylic acids such as gluconic acid and/or glucoheptonic acid.

Further suitable organic builder substances are dextrins, for example oligomers or polymers of carbohydrates, which can be obtained by partial hydrolysis of starches. The hydrolysis can be carried out by customary, for example acid-catalyzed or enzyme-catalyzed, processes. The hydrolysis products preferably have average molar masses in the range from 400 to 500 000 g/mol. Preference is given to a polysaccharide having a dextrose equivalent (DE) in the range from 0.5 to 40, in particular from 2 to 30, where DE is a common measure of the reducing action of a polysaccharide compared to dextrose, which has a DE of 100. It is also possible to use maltodextrins with a DE between 3 and 20 and dry glucose syrups with a DE between 20 and 37, and also yellow dextrins and white dextrins having relatively high molar masses in the range from 2000 to 30 000 g/mol. A preferred dextrin is described in the British patent application 94 19 091.

The oxidized derivatives of such dextrins are their reaction products with oxidizing agents which are capable of oxidizing at least one alcohol function of the saccharide ring to the carboxylic acid function. Such oxidized dextrins and processes for their preparation are known in particular from the European patent applications EP-A 0 232 202, EP-A 0 427 349, EP-A 0 472 042 and EP-A 0 542 496, and also from the international patent applications WO 92/18542, WO 93/08251, WO 93/16110, WO 94/28030, WO 95/07303, WO 95/12619 and WO 95/20608. Likewise suitable is an oxidized oligosaccharide according to the German patent application DE-A 196 00 018. A product oxidized on C₆ of the saccharide ring may be particularly advantageous.

Oxydisuccinates and other derivatives of disuccinates, preferably ethylenediamine disuccinate, are also further suitable cobuilders. In this case, ethylenediamine N,N′-disuccinate (EDDS), whose synthesis is described, for example, in the publication U.S. Pat. No. 3,158,615, is preferably used in the form of its sodium or magnesium salts. In this connection, preference is also given to glyceryl disuccinates and glyceryl trisuccinates, as described, for example, in the U.S. Pat. Nos. 4,524,009 and 4,639,325, in the European patent application EP-A 0 150 930 and in the Japanese patent application JP-A 93/339,896. Suitable use amounts in zeolite-containing and/or silicate-containing formulations are from 3 to 15% by weight.

Further organic cobuilders which can be used are, for example, acetylated hydroxycarboxylic acids or salts thereof, which may optionally also be present in lactone form and which contain at least 4 carbon atoms and at least one hydroxyl group and a maximum of two acid groups. Such cobuilders are described, for example, in the international patent application WO 95/20029.

A further class of substances having cobuilder properties is that of the phosphonates. These are in particular hydroxyalkane- and aminoalkanephosphonates. Among the hydroalkanephosphonates, 1-hydroxyethane-1,1-diphosphonate (HEDP) is of particular significance as a cobuilder. It is preferably used in the form of the sodium salt, the disodium salt giving a neutral reaction and the tetrasodium salt an alkaline reaction (pH 9). Useful aminoalkanephosphonates are preferably ethylenediaminetetramethylenephosphonate (EDTMP), diethylenetriaminepentamethylenephosphonate (DTPMP) and higher homologs thereof. They are preferably used in the form of the neutrally reacting sodium salts, for example as the hexasodium salt of EDTMP or as the hepta- and octasodium salt of DTPMP. From the class of the phosphonates, preference is given to using HEDP as a builder. In addition, the aminoalkanephosphonates have a marked heavy metal-binding capacity. Accordingly, especially when the inventive compositions also comprise bleaches, it may be preferable to use aminoalkanephosphonates, especially DTPMP, or mixtures of the phosphonates mentioned.

In addition, it is also possible to use all compounds which are capable of forming complexes with alkaline earth metal ions as cobuilders.

In a preferred embodiment, the inventive laundry detergent may optionally additionally comprise one or more complexing agents.

Complexing agents (INCI Chelating Agents), also known as sequestering agents, are ingredients which are capable of complexing and inactivating metal ions in order to prevent their disadvantageous effects on the stability or the appearance of the compositions, for example opacity. Firstly, it is important to complex the calcium and magnesium ions of water hardness which are incompatible with numerous ingredients. The complexation of the ions of heavy metals such as iron or copper delays the oxidative decomposition of the finished compositions.

Suitable complexing agents are, for example, the following designated according to INCI, which are described in detail in the Intemational Cosmetic Ingredient Dictionary and Handbook: Aminotrimethylene Phosphonic Acid, Beta-Alanine Diacetic Acid, Calcium Disodium EDTA, Citric Acid, Cyclodextrin, Cyclohexanediamine Tetraacetic Acid, Diammonium Citrate, Diammonium EDTA, Diethylenetriamine Pentamethylene Phosphonic Acid, Dipotassium EDTA, Disodium Azacycloheptane Diphosphonate, Disodium EDTA, Disodium Pyrophosphate, EDTA, Etidronic Acid, Galactaric Acid, Gluconic Acid, Glucuronic Acid, HEDTA, Hydroxypropyl Cyclodextrin, Methyl Cyclodextrin, Pentapotassium Triphosphate, Pentasodium Aminotrimethylene Phosphonate, Pentasodium Ethylenediamine Tetramethylene Phosphonate, Pentasodium Pentetate, Pentasodium Triphosphate, Pentetic Acid, Phytic Acid, Potassium Citrate, Potassium EDTMP, Potassium Gluconate, Potassium Polyphosphate, Potassium Trisphosphonomethylamine Oxide, Ribonic Acid, Sodium Chitosan Methylene Phosphonate, Sodium Citrate, Sodium Diethylenetriamine Pentamethylene Phosphonate, Sodium Dihydroxyethylglycinate, Sodium EDTMP, Sodium Gluceptate, Sodium Gluconate, Sodium Glycereth-1 Polyphosphate, Sodium Hexametaphosphate, Sodium Metaphosphate, Sodium Metasilicate, Sodium Phytate, Sodium Polydimethylglycinophenolsulfonate, Sodium Trimetaphosphate, TEA-EDTA, TEA-Polyphosphate, Tetrahydroxyethyl Ethylenediamine, Tetrahydroxypropyl Ethylenediamine, Tetrapotassium Etidronate, Tetrapotassium Pyrophosphate, Tetrasodium EDTA, Tetrasodium Etidronate, Tetrasodium Pyrophosphate, Tripotassium EDTA, Trisodium Dicarboxymethyl Alaninate, Trisodium EDTA, Trisodium HEDTA, Trisodium NTA and Trisodium Phosphate.

Preferred complexing agents are tertiary amines, in particular tertiary alkanolamines (amino alcohols). The alkanolamines have both amino and hydroxyl and/or ether groups as functional groups. Particularly preferred tertiary alkanolamines are triethanolamine and tetra-2-hydroxypropylethylenediamine (N,N,N′,N′-tetrakis(2-hydroxypropyl)ethylenediamine). Particularly preferred combinations of tertiary amines with zinc ricinoleate and one or more ethoxylated fatty alcohols as nonionic solubilizers and also optionally solvents are described in DE 40 14 055 C2 (Grillo-Werke), which is referred to in this regard and whose contents are hereby incorporated into this application.

A particularly preferred complexing agent is etidronic acid (1-hydroxyethylidene-1,1-diphosphonic acid, 1-hydroxyethane-1,1-diphosphonic acid, HEDP, acetophosphonic acid, INCI Etidronic Acid) including its salts. In a preferred embodiment, the inventive composition accordingly comprises, as a complexing agent, etidronic acid and/or one or more of its salts.

In a particular embodiment, the inventive laundry detergent comprises a complexing agent combination of one or more tertiary amines and one or more further complexing agents, preferably one or more complexing agent acids or salts thereof, in particular of triethanolamine and/or tetra-2-hydroxypropylethylenediamine and etidronic acid and/or one or more of its salts.

The inventive laundry detergent contains complexing agents in an amount of typically from 0 to 20% by weight, preferably from 0.1 to 15% by weight, in particular from 0.5 to 10% by weight, more preferably from 1 to 8% by weight, exceptionally preferably from 1.5 to 6% by weight, for example 1.5, 2.1, 3 or 4.2% by weight.

In a further embodiment, the inventive laundry detergent optionally comprises one or more viscosity regulators which preferably function as thickeners.

The viscosity of the compositions may be measured by customary standard methods (for example Brookfield RVD-VII viscometer at 20 rpm and 20° C., spindle 3) and is preferably in the range from 10 to 5000 mPas. Preferred liquid to gel-form compositions have viscosities of from 20 to 4000 mPas, particular preference being given to values between 40 and 2000 mPas.

Suitable thickeners are inorganic or polymeric organic compounds. It is also possible to use mixtures of a plurality of thickeners.

The inorganic thickeners include, for example, polysilicic acids, clay minerals such as montmorillonites, zeolites, silicas, aluminum silicates, sheet silicates and bentonites.

The organic thickeners stem from the groups of the natural polymers, of the modified natural polymers and of the fully synthetic polymers.

Polymers which stem from nature and find use as thickeners are, for example, xanthan, agar agar, carrageenan, tragacanth, gum arabic, alginates, pectins, polyoses, guar gum, gellan gum, locust bean gum, starch, dextrins, gelatin and casein.

Modified natural substances stem in particular from the group of the modified starches and celluloses; mention should be made here by way of example of carboxymethylcellulose and other cellulose ethers, hydroxyethyl- and -propylcellulose, highly etherified methylhydroxyethylcellulose and seed flour ethers.

A large group of thickeners which find wide use in a wide variety of fields of application is that of fully synthetic polymers such as polyacrylic and polymethacrylic compounds which may be crosslinked or uncrosslinked and optionally cationically modified, vinyl polymers, polycarboxylic acids, polyethers, activated polyamide derivatives, castor oil derivatives, polyimines, polyamides and polyurethanes. Examples of such polymers are acrylic resins, ethyl acrylate-acrylamide copolymers, acrylic ester-methacrylic ester copolymers, ethyl acrylate-acrylic acid-methacrylic acid copolymers, N-methylolmethacrylamide, maleic anhydride-methyl vinyl ether copolymers, polyether-polyol copolymers and butadiene-styrene copolymers.

Further suitable thickeners are derivatives of organic acids and their alkoxide adducts, for example aryl polyglycol ether, carboxylated nonylphenol ethoxylate derivatives, sodium alginate, diglyceryl monoisostearate, nonionogenic ethylene oxide adducts, coconut fatty acid diethanolamide, isododecenylsuccinic anhydride and galactomannan.

Thickeners from the substance classes mentioned are commercially available and are available, for example, under the trade names Acusol®Ò-820 (methacrylic acid (stearyl alcohol-20-EO) ester-acrylic acid copolymer, 30% in water, Rohm & Haas), Dapral®-GT-282-S (alkyl polyglycol ether, Akzo), Deuterol®-Polymer-11 (dicarboxylic acid copolymer, Schöner GmbH), Deuteron®-XG (anionic heteropolysaccharide based on β-D-glucose, D-mannose, D-glucuronic acid, Schöner GmbH), Deuteron®-XN (nonionogenic polysaccharide, Schöner GmbH), Dicrylan®-Verdicker-O (ethylene oxide adduct, 50% in water/isopropanol, Pfersse Chemie), EMA®-81 and EMA®-91 (ethylene-maleic anhydride copolymer, Monsanto), Verdicker-QR-1001 (polyurethane emulsion, 19-21% in water/diglycol ether, Rohm & Haas), Mirox®-AM (anionic acrylic acid-acrylic ester copolymer dispersion, 25% in water, Stockhausen), SER-AD-FX-1100 (hydrophobic urethane polymer, Servo Delden), Shellflo®-S (high molecular weight polysaccharide, stabilized with formaldehyde, Shell), Shellflo®-XA (xanthan biopolymer, stabilized with formaldehyde, Shell), and Kelzan, Keltrol T (Kelco).

In a further preferred embodiment, the inventive laundry detergent optionally comprises one or more enzymes. [0193] Useful enzymes are in particular those from the classes of hydrolases, such as the proteases, esterases, lipases and lipolytic enzymes, amylases, cellulases and other glycosyl hydrolases and mixtures of the enzymes mentioned. In the wash, all of these hydrolases contribute to the removal of marks, such as protein, grease or starch marks, and graying. Moreover, cellulases and other glycosyl hydrolases may, by removing pilling and microfibrils, contribute to color retention and to an increase in the softness of the textile. For bleaching or for inhibiting dye transfer it is also possible to use oxireductases. Particularly suitable enzymatic active ingredients are those obtained from bacterial strains or fungi, such as Bacillus subtilis, Bacillus licheniformis, Streptomyceus griseus and Humicola insolens. Preference is given to using proteases of the subtilisin type and in particular proteases obtained from Bacillus lentus. Of particular interest in this context are enzyme mixtures, for example mixtures of protease and amylase or protease and lipase or lipolytic enzymes or protease and cellulase or mixtures of cellulase and lipase or lipolytic enzymes or mixtures of protease, amylase and lipase or lipolytic enzymes or protease, lipase or lipolytic enzymes and cellulase, but in particular protease and/or lipase-containing mixtures, or mixtures containing lipolytic enzymes. Examples of lipolytic enzymes of this kind are the known cutinases. Peroxidases or oxidases have also been found to be suitable in some cases. Suitable amylases include in particular α-amylases, isoamylases, pullulanases and pectinases. The cellulases used are preferably cellobiohydrolases, endoglucanases and β-glucosidases, which are also called cellobiases, or mixtures thereof. Since different cellulase types differ in their CMCase and avicelase activities, it is possible to attain the desired activities by selective mixing of the cellulases.

In the form of shaped bodies, the enzymes may be adsorbed on supports or embedded in coating substances in order to protect them against premature decomposition. The content of the enzymes, enzyme mixtures or enzyme granules may, for example, be from approximately 0.1 to 5% by weight, preferably from 0.12 to approximately 2% by weight.

The laundry detergents may optionally comprise bleaches. Among the compounds which serve as bleaches and supply H₂O₂ in water, sodium percarbonate, sodium perborate tetrahydrate and sodium perborate monohydrate are of particular significance. Further usable bleaches are, for example, peroxopyrophosphates, citrate perhydrates, and also H₂O₂-supplying peracidic salts or peracids, such as persulfates or persulfuric acid. Also usable is urea peroxohydrate percarbamide, which can be described by the formula H₂N—CO—NH₂.H₂O₂. Especially when the compositions are used for the cleaning of hard surfaces, for example in machine dishwashing, they may if desired also comprise bleaches from the group of the organic bleaches, although their use is in principle also possible in compositions for textile washing. Typical organic bleaches are the diacyl peroxides, for example dibenzoyl peroxide. Further typical organic bleaches are the peroxy acids, particular examples being the alkyl peroxy acids and the aryl peroxy acids. Preferred representatives are peroxybenzoic acid and its ring-substituted derivatives such as alkylperoxybenzoic acids, but also peroxy-α-naphthoic acid and magnesium monoperphthalate, the aliphatic or substituted aliphatic peroxy acids such as peroxylauric acid, peroxystearic acid, ε-phthalimidoperoxycaproic acid (phthalimidoperoxyhexanoic acid, PAP), o-carboxybenzamidoperoxycaproic acid, N-nonenylamidoperadipic acid and N-nonenylamidopersuccinates, and aliphatic and araliphatic peroxydicarboxylic acids such as 1,12-diperoxycarboxylic acid, 1,9-diperoxyazelaic acid, diperoxysebacic acid, diperoxybrassylic acid, the diperoxyphthalic acids, 2-decyldiperoxybutane-1,4-dioic acid, N,N-terephthaloyldi(6-aminopercaproic acid) may be used.

The bleaches may be coated in order to protect them from premature decomposition.

Dyes may be used in the inventive laundry detergent, but the amount selected of one or more dyes should be sufficiently low that no visible residues remain after the use of the composition. However, the inventive composition is preferably free from dyes.

The laundry detergents may further optionally comprise UV absorbers, which attach to the treated textiles and improve the photostability of the fibers and/or the photostability of the other formulation constituents. UV absorbers refer to organic substances (light protection filters) which are capable of absorbing ultraviolet rays and emitting the energy absorbed again in the form of longer-wavelength radiation, for example heat. Compounds which have these desired properties are, for example, the compounds and derivatives of benzophenone which have substituents in the 2- and/or 4-position and are effective by virtue of radiationless deactivation. Also suitable are substituted benzotriazoles, for example the water-soluble benzenesulfonic acid 3-(2H-benzo-triazol-2-yl)-4-hydroxy-5-(methylpropyl)monosodium salt (Cibafast® H), 3-phenyl-substituted acrylates (cinnamic acid derivatives), optionally having cyano groups in the 2-position, salicylates, organic nickel complexes and natural substances such as umbelliferone and endogenous urocanic acid. Of particular significance are biphenyl derivatives and in particular stilbene derivatives as are described, for example, in EP 0728749 A and are available commercially as Tinosorb® FD or Tinosorb® FR ex Ciba. UV-B absorbers include 3-benzylidenecamphor or 3-benzylidenenorcamphor and derivatives thereof, for example 3-(4-methylbenzylidene)camphor as described in EP 0693471 B1; 4-aminobenzoic acid derivatives, preferably 2-ethylhexyl 4-(dimethylamino)benzoate, 2-octyl 4-(dimethylamino)-benzoate and amyl 4-(dimethylamino)benzoate; esters of cinnamic acid, preferably 2-ethylhexyl 4-methoxycinnamate, propyl 4-methoxycinnamate, isoamyl 4-methoxycinnamate, 2-ethylhexyl 2-cyano-3,3-phenyl-cinnamate (octocrylene); esters of salicylic acid, preferably 2-ethylhexyl salicylate, 4-isopropylbenzyl salicylate, homomenthyl salicylate; derivatives of benzophenone, preferably 2-hydroxy-4-methoxybenzophenone, 2-hydroxy-4-methoxy-4′-methylbenzophenone, 2,2′-dihydroxy-4-methoxybenzophenone; esters of benzalmalonic acid, preferably di-2-ethylhexyl 4-methoxybenzmalonate; triazine derivatives, for example 2,4,6-trianilino(p-carbo-2′-ethyl-1′-hexyloxy)-1,3,5-triazine and Octyl Triazone as described in EP 0818450 A1, or Dioctyl Butamido Triazone (Uvasorb® HEB); propane-1,3-diones, for example 1-(4-tert-butylphenyl)-3-(4′-methoxyphenyl)propane-1,3-dione; ketotricyclo(5.2.1.0)decane derivatives as described in EP 0694521 B1. Also suitable are 2-phenylbenzimidazole-5-sulfonic acid and the alkali metal, alkaline earth metal, ammonium, alkylammonium, alkanolammonium and glucammonium salts thereof; sulfonic acid derivatives of benzophenones, preferably 2-hydroxy-4-methoxybenzophenone-5-sulfonic acid and its salts; sulfonic acid derivatives of 3-benzylidenecamphor, for example 4-(2-oxo-3-bornylidenemethyl)benzenesulfonic acid and 2-methyl-5-(2-oxo-3-bornylidene)sulfonic acid and salts thereof.

Useful typical UV-A filters are in particular derivatives of benzoylmethane, for example 1-(4′-tert-butylphenyl)-3-(4′-methoxyphenyl)propane-1,3-dione, 4-tert-butyl-4′-methoxydibenzoylmethane (Parsol 1789), 1-phenyl-3-(4′-isopropylphenyl)propane-1,3-dione, and enamine compounds, as described in DE 19712033 Al (BASF). The UV-A and UV-B filters can of course also be used in mixtures. In addition to the soluble substances mentioned, insoluble light protection pigments are also suitable for this purpose, specifically finely dispersed, preferably nanoized, metal oxides or salts. Examples of suitable metal oxides are in particular zinc oxide and titanium dioxide and additionally oxides of iron, zirconium, silicon, manganese, aluminum and cerium, and mixtures thereof. The salts used may be silicates (talc), barium sulfate or zinc stearate. The oxides and salts are already used in the form of pigments for skincare and skin-protecting emulsions and decorative cosmetics. The particles should have an average diameter of less than 100 nm, preferably between 5 and 50 nm and in particular between 15 and 30 nm. They may have a spherical shape, although it is also possible to use particles which have an ellipsoidal shape or a shape which deviates in some other way from the spherical form. The pigments may also be surface-treated, i.e. hydrophilicized or hydrophobicized. Typical examples are coated titanium dioxides, for example titanium dioxide T 805 (Degussa) or Eusolex® T2000 (Merck). Useful hydrophobic coating compositions are in particular silicones and especially trialkoxyoctylsilanes or simethicones. Preference is given to using micronized zinc oxide. Further suitable UV light protection filters can be taken from the review of P. Finkel in SÖFW-Journal 122, 543 (1996).

The UV absorbers may be used in amounts of from 0.01% by weight to 5% by weight, preferably of from 0.03% by weight to 1% by weight.

The laundry detergents may further optionally comprise ironing aids to improve the water absorption capacity and the rewettability of the treated textiles, and to ease the ironing of these textiles. In the formulations, it is possible to use, for example, silicone derivatives. They additionally improve the rinse-out performance of the washing formulations by virtue of their foam-inhibiting properties. Preferred silicone derivatives are, for example, polydialkyl- or alkylarylsiloxanes in which the alkyl groups have from one to five carbon atoms and are fully or partly fluorinated. Preferred silicones are polydimethylsiloxanes which may optionally be derivatized and are in that case amino-functional or quaternized or have Si—OH, Si—H and/or Si—Cl bonds. The viscosities of the preferred silicones at 25° C. are in the range between 100 and 100 000 mPas, and the silicones may be used in amounts between 0.2 and 5% by weight, based on the overall composition.

The laundry detergents may further optionally comprise anticrease agents or crease-reduction agents. These include, for example, synthetic products based on fatty acids, fatty acid esters, fatty acid amides, fatty acid alkylol esters, fatty acid alkylolamides or fatty alcohols, which have usually been reacted with ethylene oxide, or products based on lecithin or modified phosphoric esters.

The invention further provides a conditioning substrate for use in textile drying processes which has been impregnated and/or coated and/or saturated with an inventive composition. The form of configuration of the impregnating, coating or saturating composition can be taken from the above description.

Conditioning substrates find use in particular in textile treatment and in particular in textile drying processes. The substrate material consists preferably of porous flat cloths. They may consist of a fibrous or cellular flexible material which has sufficient thermal stability for use in the dryer and which can retain sufficient amounts of an impregnating or coating composition in order to condition substances effectively without significant leaking or leaching of the composition. These cloths include cloths made of woven and nonwoven synthetic and natural fibers, felt, paper or foam, such as hydrophilic polyurethane foam.

Preference is given here to using conventional cloths made of nonwoven material (nonwovens). Nonwovens are generally defined as adhesively bonded fibrous products which have a mat or coated fiber structure, or those which comprise fiber mats in which the fibers are distributed randomly or in statistic arrangement. The fibers may be natural, such as wool, silk, jute, hemp, cotton, linen, sisal or ramie; or synthetic, such as rayon, cellulose esters, polyvinyl derivatives, polyolefins, polyamides or polyesters. In general, any fiber diameter and linear density is suitable for the present invention. Owing to the random or statistic arrangement of fibers in the nonwoven material, which impart excellent strength in all directions, the nonwoven substances used here do not tend to tear or disintegrate when they are used, for example, in a domestic laundry dryer. Examples of nonwoven substances which are suitable as substrates in the present invention are known, for example, from WO 93/23603. Preferred porous and flat conditioning cloths consist of one or different fiber materials, in particular of cotton, finished cotton, polyamide, polyesters or mixtures thereof. The conditioning substrates in cloth form preferably have a surface area of from 0.2 to 0.005 m², preferably from 0.15 to 0.01 m^{2,} in particular from 0.1 to 0.03 m² and more preferably from 0.09 to 0.06 m². The density of the material is typically between 20 and 1000 g/m², preferably from 30 to 500 g/m² and in particular from 50 to 150 g/m². Conditioning substrates may be obtained by saturation or impregnation, or else by melting of the inventive compositions or conditioning compositions onto a substrate.

Accordingly, this invention further provides a textile conditioning process in which one or more conditioning substrates according to the remarks just made are used in a textile drying process.

This invention likewise further provides for the use of a composition which is suitable for textile treatment and comprises at least one or more skin-healing and/or skin-protecting active substances in the sense of the invention, the skin-healing and/or skin-protecting active substance advantageously having antiseptic action, preferably being an oil and more preferably being an essential oil, in particular selected from the essential oils mentioned by name above.

In a preferred embodiment, the use of a composition which has just been described and is suitable for textile treatment is accompanied by at least one healing active substance being transferred in the course of the textile treatment to the fibers of an appropriately treated textile and also, on skin contact, remaining at least partly on the textile, even if only in traces, with the proviso that at least a portion of this healing active substance, on contact of the skin with an appropriately treated textile, is released therefrom to the skin.

In a preferred embodiment, this invention further provides for the use of at least one skin-protecting and/or skin-healing active substance for producing a medically active textile treatment composition according to the features of the inventive textile treatment composition which can be taken from the description for finishing textiles for the sustaining treatment of irritated and/or sensitized and/or diseased human skin, and for the prophylactic treatment of healthy skin.

In a preferred embodiment, this invention further provides for the use of at least one skin-protecting and/or skin-healing active substance for producing a medically active conditioning substrate according to the features which can be taken from the description for finishing textiles for the sustaining and/or prophylactic treatment of healthy and/or irritated and/or sensitized and/or diseased human skin.

In a preferred embodiment, this invention further provides for the use of at least one skin-protecting and/or skin-healing active substance for producing a medically active laundry detergent according to the features which can be taken from the description for finishing textiles for the sustaining and/or prophylactic treatment of healthy and/or irritated and/or sensitized and/or diseased human skin.

### EXAMPLE

A formulation for a medical textile treatment composition in the sense of this invention is specified below.

It is a milk (emulsion) consisting of:

| | |
|---|---|
| Per use = 45 g | Per kg of product |

| | | | |
|---|---|---|---|
| 1 | g of citric acid | 22.2 | g |
| 1 | g of sodium citrate | 22.2 | g |
| 2 | g of urea | 44.4 | g |
| 0.5 | g of degraded starch | 11.1 | g |
| 0.2 | g of castor oil + 40 EO | 4.4 | g |
| 3 | g of almond oil | 66.6 | g |
| 3 | g of hemp oil | 66.6 | g |
| 3 | g of borage oil | 66.6 | g |
| 2 | g of tea tree oil | 44.4 | g |
| 29.3 | g of water | 651.5 | g |

| | |
|---|---|
| Total 45 g | 1000 g corresponds to |
| | 22 uses |

The emulsion was prepared in a laboratory homogenizer (rotor-stator system, from Janke & Kunkel) at 30° C. with subsequent cooling to 20° C. The degraded starch is a natural starch from rice, maize, wheat, potato, oat and the like, preferably partially hydrolyzed starch (acidic or enzymatic hydrolysis).

The solids citric acid, sodium citrate, urea and starch are dissolved with stirring successively at approx. 30° C. in the initially charged water. Subsequently, the oils and the emulsifier (ethoxylated castor oil) are added successively. The emulsion is obtained by use of a homogenizer.

This emulsion can be applied in all of the above-described ways in the context of a textile treatment.

Two methods will be described below which are suitable for demonstrating the transfer of active substances from textiles to the skin. The demonstration is in each case preceded by a phase in which a number of test subjects (typically 10-50) wear the textile for a defined period, or a sample of the textile is fixed to the back or arm of the test subjects. The skin of the test subjects may also optionally be rubbed with the textile for one minute.

Detection Method 1 (preferred): Tape Strippings

For in vivo sampling, Sebutapes® are applied for one minute in each case to three points on the inner side of the underarm or the sites in question on the body at which there was textile/skin contact. A roller (1000 g) is rolled six times in a standardized procedure over the area covered with adhesive tape.

For quantification of the proteins on the Sebutapes®, they are admixed with in each case 1.5 ml of the lysis buffer (0.9% by weight of NaCl+0.1% by weight of Triton X in double-distilled water). The treatment was effected in 6 corrugated dishes which were sealed carefully with Parafilm. In each case three plates are treated together in the ultrasound bath for 10 minutes. The overall protein content is quantified by a standard method, for example with the microBCA protein assay from Pierce according to the manufacturer's instructions.

To quantify the active substance, it is eluted from the Sebutapes with a suitable buffer. The analysis is effected with suitable methods (e.g. HPLC/GC/MS or others).

Detection Method 2: Elution

After the textiles had been worn on the skin for one day, the active substances are extracted from the skin by means of a cotton pad with 2 ml of analytically pure ethanol.

A plastic ring with an internal diameter of 40 mm is laid onto the skin, and the skin area to be tested is extracted 3 times with circular motion.

The pad is deposited into 8 ml units of analytical ethanol. The active substances are subsequently quantified, for example, by means of HPLC/GC/MS or other customary analytical methods.

In these two methods, the activity of the active substances is regarded as proven. They document the transfer of the active substances from the textile to the skin.

For a demonstration of activity, a further test is required. To this end, comparative experiments have to be carried out, for example the following a) and b).
a) There was slight existing damage of the skin, whose more rapid regeneration was observed by applying the textile in comparison to an untreated area. Suitable methods for assessing the (more rapid) regeneration are, for example, optical evaluation, measurement of the TEWL (transepidermal water loss), skin pH.
b) Assessment of textiles treated in accordance with the invention by test subjects having skin with slight existing damage in comparison to conventionally treated textiles. The test subjects had to wear both types of textiles over a defined period (8 hours) and then assess whether the wearing of the different textiles resulted in perception of an effect on the skin, for example a reduction in pruritus or another effect which is noticed by the test subject having damaged skin and improves his or her subjective well-being.

1. A textile aftertreatment composition comprising (a) a skin-protecting oil selected from the group of: algae oil Oleum Phaeophyceae, apricot kernel oil Prunus armeniaca, arnica oil Arnica montana, avocado oil Persea americana, borage oil Borago officinalis, calendula oil Calendula officinalis, camellia oil Camellia oleifera, thistle oil Carthamus tinctorius, peanut oil Arachis hypogaea, hemp oil Cannabis sativa, hazelnut oil Corylus avellana, St. John's wort oil Hypericum perforatum, jojoba oil Simondsia chinensis, carrot oil Daucus carota, coconut oil Cocos nucifera, pumpkinseed oil Curcubita pepo, kukui nut oil Aleurites moluccana, macadamia nut oil Macadamia ternifolia, almond oil Prunus dulcis, peach kernel oil Prunus persica, rapeseed oil Brassica oleifera, black cumin oil Nigella sativa, sesame oil Sesamium indicum, sunflower oil Helianthus annus, grapeseed oil Vitis vinifera, walnut oil Juglans regia, wheatgerm oil Triticum sativum, and (b) urea and/or urea derivative; lactic acid and/or a lactic salt; citric acid and/or a citric acid salt wherein the composition is in the form of an emulsion.

2. The composition of claim 1, wherein the skin-protecting oil exhibits antiseptic activity whereby the natural flora of the skin is maintained.

3. The composition of claim 2, wherein the skin-protecting oil an essential oil.

4. The composition of claim 1, wherein the amount of the skin-protecting oil in the composition is at least 1% by weight.

5. The composition of claim 1, wherein the skin-protecting has a minimum content of 0.1% by weight of γ-linolenic acid.

6. The composition of claim 1, wherein the pH at a temperature of T=20° C. is not greater than 5.5.

7. The composition of claim 1, wherein the composition is dye-free.

8. The composition of claim 1, wherein the composition is a solid, dispersed, pulverulent, pressed or granular form.

9. The composition of claim 1, wherein the composition is a liquid.

10. A nonaqueous liquid comprised of the composition of claim 1.

11. The composition of claim 1, wherein the composition is free of additional fragrances or other perfume oils are present.

12. The composition of claim 1 further comprising an easy-iron agent and/or crease reduction agent.

13. A composite material comprised of the composition of claim 1 and a polymeric substrate wherein the composition of claim 1 is reversibly fixed to the substrate whereby the composition of claim 1 is released in a delayed manner.

14. The composite material of claim 13, wherein the polymeric support is a silicic ester.

15. The composition of claim 1 further comprising a deodorizing active ingredient.

16. A water-soluble package comprising the composition of claim 1.

17. A composition comprising a plurality of water-soluble packages, wherein each package is comprised of the composition of claim 1.

18. A tablet comprising the composition of claim 1.

19. The tablet of claim 18, wherein at least a portion of the components of the composition of claim 1 are in separate phases.

20. The composition of claim 1, wherein the composition is in the form of a microemulsion.

21. A method of treating a textile comprising contacting the textile with the composition of claim 1, wherein the composition is applied as an after rinse.

22. The method of claim 21, wherein the composition is applied in liquid form to the textile by means of a spray applicator.

23. A composite material comprising a textile substrate and a composition of claim 1.

24. The composite of claim 23, wherein the substrate is a nonwoven material.

25. The composite of claim 24, wherein the substrate is a viscose nonwoven.

26. The substrate of claim 25, wherein the surface area is from 0.2 to 0.005 m².
